(19) United States
(12) Patent Application Publication
(10) Pub. No.: US 2021/0342730 A1
(43) Pub. Date: Nov. 4, 2021

(54) SYSTEM AND METHOD OF QUANTUM ENHANCED ACCELERATED NEURAL NETWORK TRAINING

(71) Applicant: equal1.labs Inc., Fremont, CA (US)

(72) Inventors: David J. Redmond, Cork (IE); Dirk Robert Walter Leipold, Fremont, CA (US)

(21) Appl. No.: 17/302,402

(22) Filed: May 1, 2021

Related U.S. Application Data
(60) Provisional application No. 63/018,714, filed on May 1, 2020.

(51) Int. Cl. G06N 10/00; G06N 3/04; G06N 3/08

(52) U.S. Cl. CPC G06N 10/00; G06N 3/08; G06N 3/04

(57) ABSTRACT

A novel and useful system and method of quantum enhanced accelerated training of a classic neural network (NN). The quantum system implements an optimizer that accelerates training of the classic NN by exploiting the properties of quantum mechanics and manipulating the quantum system into a state that represents the complete state of the classic NN, including the loss function. The quantum system is then allowed to transition to its “optimum state” and the minimum energy state is read out from detectors and weight updates are calculated and fed back to the classic NN. Mapping and detection helper neural networks learn the characteristics of the quantum system structures. By averaging this over a number of images the learning weight or gradient of descent can be controlled to yield optimum neural network parameters. The time and energy required for training the classic NN as well as for inference is drastically reduced.

### REFERENCE TO PRIORITY APPLICATIONS

This application claims the benefit of U.S. Provisional Application No. 63/018,714, filed May 1, 2020, entitled “Training On The Fly,” incorporated herein by reference in its entirety.

### FIELD OF THE DISCLOSURE

The subject matter disclosed herein relates to the field of quantum computing and more particularly relates to a system and method of quantum enhanced accelerated training of neural networks.

### BACKGROUND OF THE INVENTION

Quantum computing is a new paradigm that exploits fundamental principles of quantum mechanics, such as superposition and entanglement, to tackle problems in mathematics, chemistry and material science that are well beyond the reach of supercomputers. Its power is derived from a quantum bit (qubit), which can simultaneously exist as a superposition of both 0 and 1 states and can become entangled with other qubits. This leads to doubling the computational power with each additional qubit, which can be repeated many times. It has been already shown that quantum computers can speedup some of the algorithms and, potentially, model any physical process.

Currently, modern artificial intelligence (AI) models consume a massive amount of energy, and these energy requirements are growing at a breathtaking rate. In the era of deep learning, the computational resources needed to produce a best-in-class AI model has on average doubled approximately every 3.4 months. This translates to a 300,000× increase between 2012 and 2018. For example, OpenAI built a very large AI model GPT-3 consisting of 175 billion parameters. The previous model GPT-2 had 1.5 billion parameters which took a few dozen petaflop-days to train. The GPT-3 model requires several thousand petaflop-days to train.

A problem with ever larger neural network models is that building and deploying these models entails a tremendous amount of energy which translates to carbon emissions. In addition, the time to train such models is measured in days and weeks. The reason machine learning models consume so much energy is because the datasets used to train these models continue to balloon in size. For example, the BERT model achieved superior natural language processing (NLP) performance after it was trained on a dataset of three billon words. The XLNet model outperformed BERT on a training set of 32 billion words. The GPT-2 model was trained on a dataset of 40 billion words. A weights dataset of approximately 500 billion words was used to train the GPT-3 model.

As another example, consider that the major trend in the medical sector is the increased use of imaging techniques which leads to large amounts of complex data in the form of, e.g., x-rays, CAT scans, and MRIs. While imaging as a technique in medical practice is increasing, and consequently the workload associated with the analysis of this data, the number of trained radiologists stays more or less constant. Research published by IBM estimates that medical images currently account for greater than 90% all medical data. This amount of data is surpassing the normally available processing power so much of it is largely ignored, and coupled with overworked radiologists, there is a growing gap and need for a workable solution before the problem becomes more acute.

Developments in deep learning models showed that comparable performance with an expert radiologist can be achieved while greatly improving the efficiency of radiologists in clinical practice. Thus AI holds great potential to relieve the pressure of frontline radiologists, improve early diagnosis, isolation and treatment, and thus contribute to the control of the epidemic. Fundamentally, deep learning algorithms excel at automatically learning and recognizing complex patterns in unstructured data. For medical imaging, deep learning is therefore particularly interesting. There are, however, many other inherent problems with medical image datasets as described below.

Regarding training times deep learning requires very large data sets in order to reach the required levels of accuracy particularly for a medical diagnosis, and with these large datasets comes the penalty of extremely long training run times, and the need for access to high performance computers. With many new sources of biomedical data becoming available, training cycle times of several days and weeks mean valuable information is lost.

Regarding the accuracy of the model, extracting a diagnosis from biomedical images requires a different metric for classification, given the consequences of the outcome.

Also privacy is an issue that has been getting much attention recently in almost all areas. In addition, data sharing is a complex issue, especially in the medical sector. The direct impact to AI medical imaging is the sharing of labels in the datasets, which reduces the total amount of useful data on which to train. As part of any natural occurring training set there will be errors in the labeling. These errors actually oftentimes can improve the algorithm, but in a context of medical datasets accuracy of labeling is not always assured. There are also political factors influencing the transparency of labeled data.

The explainability of a deep learning model is hard to uncover and interpret, so the rationale behind the reasoning as to why a particular decision is correct often remains elusive. Recently, a number of prestigious publications that attempted to explain even minor algorithm improvements have been subsequently disproved. This contributes to the difficulty in providing a credible rational of deep learning's findings.

Development of new models and algorithms is moving at a very high pace with researchers publishing incremental improvements daily, however these innovations are not always easy to compare across a broad selection of biomedical images datasets, and the metrics can also be subjective.

Distributed deep learning and similar advanced techniques that employ data and model parallelism provide some speed up in the training. These techniques, however, still struggle with the bottleneck caused by the sequential nature of gradient descent, and are generally beyond the reach of most medical institutions.

Regarding cost and carbon footprint, several cost examples were provided supra. In another example, the cost for an entry level network like ResNet50 ImageNet with 26 epochs ˜90 to 100 mins at $11-$16 for a moderate accuracy of ˜93%. In addition, the BERT models emit a carbon dioxide footprint of 1438 CO₂ₑ at a cloud compute cost of $3,751-$12,571 using a cluster of 64 V100 TPUs.

Note that today's current solutions use large scale training with large datasets that run on distributed deep learning clusters, usually of the latest TPUs often hosted by Google, Microsoft, Nvidia, AWS, and others. These clusters, however, are very power inefficient, expensive to run, have limited accessibly via batch or queuing systems, do not scale to wide scale deployment where data privacy, proprietary information, or citizens rights maybe a factor.

In operation, neural networks carry out a lengthy set of mathematical operations (both forward propagation and back propagation) for each piece of data they are fed during training, updating their parameters in complex ways. Larger datasets therefore translate to soaring compute and energy requirements.

Also driving AI energy consumption is the extensive experimentation and tuning required to develop a model. Machine learning today remains largely an exercise in trial and error. Practitioners often build hundreds of versions of a given model during training, experimenting with different neural architectures and hyperparameters before identifying an optimal design. For the GPT-3 model, 4,789 different versions were trained, requiring 9,998 total days' worth of GPU time (more than 27 years).

The process of inference whereby AI models are deployed to take action in real-world settings consumes even more energy than training does. It is estimated that 80% to 90% of the cost of a neural network is in inference rather than training. Unlike training, once a network is trained, inference may be performed constantly such as in an autonomous vehicle in order to navigate its environment while the vehicle is in use. The more parameters the model has, the steeper the energy requirements are for the ongoing inference.

Deep learning is a branch of machine learning that uses a layered architecture of data processing stages for pattern recognition. Due to its effectiveness in many applications, deep learning has gained popularity in both academia and industry. Currently, convolutional neural networks (CNNs) are the most successful models for deep learning, and they are used in numerous domains.

In general, convolutional neural networks simulate the way in which human brains process and recognize images. They belong to the family of multi-layer perceptrons (MLP). A MLP is a multi-layer neural network consisting of an input layer, an output layer and multiple hidden layers between the input and output layers. Each hidden layer represents a function between its inputs and outputs that is defined by the layer's parameters.

Convolutional neural networks mainly consist of three types of layers: convolutional layers, pooling layers, and fully connected layers. Each layer may contain hundreds, thousands or millions of neurons. A single neuron takes inputs, optionally adds a bias, applies weights to each input to compute their weighted sum, typically applies a nonlinear function on it, and sends the output to the neurons in the next layer. In this way, distinct layers apply different operations to their inputs and produce outputs for subsequent layers.

Convolutional layers apply convolutions to the input with several filters and add a bias term to the results. Very often, a nonlinear function called an activation function is applied to the results. Convolutional layers exploit spatial connectivity and shared weights. The parameters of a convolutional layer are reduced dramatically compared to a typical hidden layer of a MLP. Convolutional layers are the most computationally intensive layers in CNNs.

Pooling layers perform a nonlinear down-sampling operation on the input. They partition the input into a set of sub-regions and output sampled results from these sub-regions. Based on their sampling method, pooling layers can be categorized into: maximum pooling, average pooling, and stochastic pooling. Pooling layers progressively reduce the number of parameters as well as control model overfitting. Pooling layers are usually placed between two convolutional layers.

Unlike in convolutional layers, neurons in fully connected layers have full connections to all output from the preceding layers. As a consequence, a fully connected layer has many more parameters than a convolutional layer. Nonetheless, since convolution operations are replaced by multiplications, fully connected layers require less computational power.

Using CNNs for machine learning tasks involves three steps: (1) designing the CNN architecture, (2) learning the parameters of the CNN (also called “training”), and (3) using the defined CNN for inference. Since CNNs are backpropagation learning algorithms, their learning phases can be divided into: forward propagation, backward propagation, and weight update. In the forward propagation phase, input data are sent to the neural network to generate the outputs. In the backward propagation phase, the errors between the standard outputs and the produced outputs are propagated in a backward fashion to compute the errors in each layer. These errors, i.e. gradients, in each layer will be used in every weight update. For inference, however, the parameters of the networks are given and there is only forward propagation to produce the prediction.

There is thus a need for a mechanism to drastically reduce the energy consumption a neural network consumes both during training and inference. At the same time, such a mechanism should also reduce the time required for training and inference operations.

### SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

The present invention makes use of a quantum system or quantum computer to accelerate training of a chosen neural network algorithm used for a specific application. Using the appropriate training dataset, in the forward pass the optimum weights/parameters are extracted in a single pass. This is achieved by exploiting the properties of the quantum hardware, by manipulating the quantum system into a state that represents the complete state of the CNN, including the loss function. The quantum system is then allowed to transition to its “optimum state” and the output state of the quantum system is then read out, from which the optimum parameters for that training image can be inferred.

This is achieved though one or more helper neural networks that learn the (1) characteristics of the quantum system structures, (2) resultant quantum states and behavior to an orchestrated series of impulses, and (3) measured responses to the series of impulses. By averaging this over a number of images the learning weight or gradient of descent can be controlled to yield optimum neural network parameters. An important feature of the system is that the time for the quantum state to reach the optimum state is in the order of the decoherence time (i.e. nanoseconds). This drastically reduces the time required for training as well as for inference eliminating long training times for large datasets that repeatedly run, i.e. multiple epochs. It also solves the problem of sparse or small datasets. Further, with the huge speed up in time, it allows many different deep learning and complex algorithms to be run on the same dataset to find the best algorithm for a specific application.

The quantum system may comprise a quantum dot array (QDA) of qudits that is wrapped by two helper neural networks before and after it. The first helper neural network (or mapping neural network) functions to filter the input data which is the activation function and loss vector outputs from the classic neural network to generate a reduced number of activations and to map these to energy levels in the quantum system. The quantum system performs an energy based optimization on the compressed data. Detector output measurements are taken (small sample size) which are fanned out to a large number of weight updates by the second helper neural network (or detection neural network).

Advantages of the mechanism of the present invention include the speed of training and convergence to optimum parameters which allows many new datasets and new architectures to be benchmarked within a faction of the cost, energy, and time of traditional networks. The consequences are dramatic especially for large super networks tailored for specific AI applications.

Quantum computers are machines that perform computations using the quantum effects between elementary particles, e.g., electrons, holes, ions, photons, atoms, molecules, etc. Quantum computing utilizes quantum-mechanical phenomena such as superposition and entanglement to perform computation. Quantum computing is fundamentally linked to the superposition and entanglement effects and the processing of the resulting entanglement states. A quantum computer is used to perform such computations which can be implemented theoretically or physically.

Currently, analog and digital are the two main approaches to physically implementing a quantum computer. Analog approaches are further divided into quantum simulation, quantum annealing, and adiabatic quantum computation. Digital quantum computers use quantum logic gates to do computation. Both approaches use quantum bits referred to as qubits.

Qubits are fundamental to quantum computing and are somewhat analogous to bits in a classical computer. Qubits can be in a |0> or |1> quantum state but they can also be in a superposition of the |0> and |1> states. When qubits are measured, however, they always yield a |0> or a |1> based on the quantum state they were in.

One challenge of quantum computing is isolating such microscopic particles, loading them with the desired information, letting them interact and then preserving the result of their quantum interaction. This requires relatively good isolation from the outside world and a large suppression of the noise generated by the particle itself. Therefore, quantum structures and computers operate at very low temperatures (e.g., cryogenic), close to the absolute zero kelvin (K), in order to reduce the thermal energy/movement of the particles to well below the energy/movement coming from their desired interaction. Current physical quantum computers, however, are very noisy and quantum error correction is commonly applied to compensate for the noise.

Most existing quantum computers use superconducting structures to realize quantum interactions. Their main drawbacks, however, are the fact that superconducting structures are very large and costly and have difficulty in scaling to quantum processor sizes of thousands or millions of quantum-bits (qubits). Furthermore, they need to operate at few tens of millikelvin (mK) temperatures, that are difficult to achieve and where it is difficult to dissipate significant power to operate the quantum machine.

This, additional, and/or other aspects and/or advantages of the embodiments of the present invention are set forth in the detailed description which follows; possibly inferable from the detailed description; and/or learnable by practice of the embodiments of the present invention.

There is thus provided in accordance with the invention, a method of quantum enhanced accelerated training of a neural network, said method comprising receiving a plurality of activation function tensors corresponding to features across layers in the neural network, mapping said plurality of activation function tensors of the neural network to energy levels representing a quantum state in a quantum system, detecting minimum energy states at one or more observation points in said quantum system after said quantum system converges to a minimum total energy, and determining an update to one or more neural network parameters in accordance with said one or more minimum energy states detected.

There is also provided in accordance with the invention, a quantum optimizer apparatus for accelerating training of a neural network, comprising a quantum system, a classic processor coupled to said quantum system and operative to receive one or more neural network activation function tensors, compress said activation function tensor utilizing an energy based model, map activation energy represented by said energy based model to quantum states in said quantum system, detect an energy state at one or more observation ports in said quantum system after said quantum system collapses to a minimum total energy, and determine updates to one or more neural network parameters in accordance with one or more energy states detected.

There is further provided in accordance with the invention, a method of quantum enhanced accelerated training of a neural network, said method comprising receiving a plurality of activation function tensors corresponding to features and layers in the neural network, compressing said plurality of activation function tensors of the neural network utilizing an energy based model to reduce the number of activation function tensors, mapping said reduced number of activation function tensors signals to energy levels representing quantum state in a quantum dot array incorporating a plurality of quantum dots, detecting minimum energy states at one or more observation points in said quantum dot array once said quantum dot array converges to a minimum total energy, and determining an update to one or more neural network parameters in accordance with said one or more minimum energy states detected.

There is also provided in accordance with the invention, a quantum optimizer apparatus for accelerating training of a neural network, comprising a quantum system, a first neural network coupled to said quantum system and operative to compress a plurality of activation and loss function outputs from a classic neural network utilizing an energy based model to generate a reduced number of activation and loss function outputs, map the reduced number of activation and loss function outputs to unique quantum state energy levels in said quantum system, wherein said first neural network is operative to select an optimum choice of frequencies and pulse durations to apply to said quantum system, a circuit operative to apply said energy level mappings to said quantum system, a plurality of detectors operative to detect an energy state at one or more observation ports in said quantum system after said quantum system evolves to a minimum total energy, and a second neural network coupled to said quantum system and operative to generate updates to one or more neural network parameters to said classic neural network in accordance with a plurality of detected energy states thereby training said classic neural network.

### BRIEF DESCRIPTION OF THE DRAWINGS

The present invention is explained in further detail in the following exemplary embodiments and with reference to the figures, where identical or similar elements may be partly indicated by the same or similar reference numerals, and the features of various exemplary embodiments being combinable. The invention is herein described, by way of example only, with reference to the accompanying drawings, wherein:

FIG. 1 is a high level block diagram illustrating an example quantum computer system constructed in accordance with the present invention;

FIG. 2 is a high level block diagram illustrating a first example quantum accelerated neural network training system;

FIG. 3 is a diagram illustrating a first example quantum system integrated on a single chip;

FIG. 4 is a diagram illustrating a second example quantum system of two quantum dots;

FIG. 5 is a diagram illustrating a third example quantum system of three quantum dots;

FIG. 6 is a diagram illustrating a fourth example quantum system arranged in multiple rows of quantum dots;

FIG. 7 is a diagram illustrating a fifth example quantum system arranged in multiple staggered rows of quantum dots;

FIG. 8 is a diagram illustrating a sixth example quantum system arranged in a double ‘V’ shaped array of quantum dots;

FIG. 9 is a diagram illustrating a top view of the array of FIG. 8;

FIG. 10 is a diagram illustrating a cross sectional view of the array of FIG. 8;

FIG. 11A is a diagram illustrating an example floating gate detection circuit;

FIG. 11B is a diagram illustrating the layout for the example floating gate detection circuit;

FIG. 11C is a diagram illustrating the cross section for the floating gate detection circuit;

FIG. 12 is an example potential diagram for the floating gate detection circuit;

FIG. 13 is a high level block diagram illustrating an example capacitive DAC based pulse generator coupled to the quantum core;

FIG. 14 is a high level block diagram illustrating an example quantum core interface circuit;

FIG. 15 is a timing diagram of the signals of the quantum core interface circuit of FIG. 15;

FIG. 16 is a high level top block diagram illustrating an example quantum system on chip (SoC);

FIG. 17 is a diagram illustrating the potential energy as a function of distance for the three quantum dot system of FIG. 5;

FIG. 18 is a diagram illustrating the wave functions as a function of distance for the three quantum dot system of FIG. 5;

FIG. 19 is a diagram illustrating the possible energy levels for each of the three quantum dot system of FIG. 5;

FIG. 20 is a diagram illustrating the spectrum of two-particle states for the three quantum dot system of FIG. 5;

FIG. 21 is a high level block diagram illustrating a second example quantum accelerated neural network training system;

FIG. 22 is a flow diagram illustrating an example method of quantum based accelerated training of a neural network;

FIG. 23 is a high level block diagram illustrating example quantum accelerated neural network inference;

FIG. 24 is a diagram illustrating example assignment of frequencies to activation function output;

FIG. 25 is a high level block diagram illustrating a first example time and tensor shape matched and balanced architecture; and

FIG. 26 is a high level block diagram illustrating a second example time and tensor shape matched and balanced architecture.

### DETAILED DESCRIPTION

In the following detailed description, numerous specific details are set forth in order to provide a thorough understanding of the invention. It will be understood by those skilled in the art, however, that the present invention may be practiced without these specific details. In other instances, well-known methods, procedures, and components have not been described in detail so as not to obscure the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary, for the understanding and appreciation of the underlying concepts of the present invention and in order not to obfuscate or distract from the teachings of the present invention.

Any reference in the specification to a method should be applied mutatis mutandis to a system capable of executing the method. Any reference in the specification to a system should be applied mutatis mutandis to a method that may be executed by the system.

Throughout the specification and claims, the following terms take the meanings explicitly associated herein, unless the context clearly dictates otherwise. The phrases “in one embodiment,” “in an example embodiment,” and “in some embodiments” as used herein do not necessarily refer to the same embodiment(s), though it may. Furthermore, the phrases “in another embodiment,” “in an alternative embodiment,” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following definitions apply throughout this document.

A quantum particle is defined as any atomic or subatomic particle suitable for use in achieving the controllable quantum effect. Examples include electrons, holes, ions, photons, atoms, molecules, artificial atoms. A carrier is defined as an electron or a hole in the case of semiconductor electrostatic qubit. Note that a particle may be split and present in multiple quantum dots. Thus, a reference to a particle also includes split particles.

In quantum computing, the qubit is the basic unit of quantum information, i.e. the quantum version of the classical binary bit physically realized with a two-state device. A qubit is a two state quantum mechanical system in which the states can be in a superposition. Examples include (1) the spin of the particle (e.g., electron, hole) in which the two levels can be taken as spin up and spin down; (2) the polarization of a single photon in which the two states can be taken to be the vertical polarization and the horizontal polarization; and (3) the position of the particle (e.g., electron) in a structure of two qdots, in which the two states correspond to the particle being in one qdot or the other. In a classical system, a bit is in either one state or the other. Quantum mechanics, however, allows the qubit to be in a coherent superposition of both states simultaneously, a property fundamental to quantum mechanics and quantum computing. Multiple qubits can be further entangled with each other.

A quantum dot or qdot (also referred to in literature as QD) is a nanometer-scale structure where the addition or removal of a particle changes its properties is some ways. In one embodiment, quantum dots are constructed in silicon semiconductor material having typical dimension in nanometers. The position of a particle in a qdot can attain several states. Qdots are used to form qubits and qudits where multiple qubits or qudits are used as a basis to implement quantum processors and computers.

A quantum interaction gate is defined as a basic quantum logic circuit operating on a small number of qubits or qudits. They are the building blocks of quantum circuits, just like the classical logic gates are for conventional digital circuits.

A qubit or quantum bit is defined as a two state (two level) quantum structure and is the basic unit of quantum information. A qudit is defined as a d-state (d-level) quantum structure. A qubyte is a collection of eight qubits.

The terms control gate and control terminal are intended to refer to the semiconductor structure fabricated over a continuous well with a local depleted region and which divides the well into two or more qdots. These terms are not to be confused with quantum gates or classical FET gates.

Unlike most classical logic gates, quantum logic gates are reversible. It is possible, however, although cumbersome in practice, to perform classical computing using only reversible gates. For example, the reversible Toffoli gate can implement all Boolean functions, often at the cost of having to use ancillary bits. The Toffoli gate has a direct quantum equivalent, demonstrating that quantum circuits can perform all operations performed by classical circuits.

A quantum well is defined as a very small (e.g., typically nanometer scale) two dimensional area of metal or semiconductor that functions to contain a single or a small number of quantum particles. It differs from a classic semiconductor well which might not attempt to contain a small number of particles or/and preserve their quantum properties. One purpose of the quantum well is to realize a function of a qubit or qudit. It attempts to approximate a quantum dot, which is a mathematical zero-dimensional construct. The quantum well can be realized as a low doped or undoped continuous depleted semiconductor well partitioned into smaller quantum wells by means of control gates. The quantum well may or may not have contacts and metal on top. A quantum well holds one free carrier at a time or at most a few carriers that can exhibit single carrier behavior.

A classic well is a medium or high doped semiconductor well contacted with metal layers to other devices and usually has a large number of free carriers that behave in a collective way, sometimes denoted as a “sea of electrons.”

A quantum structure or circuit is a plurality of quantum interaction gates. A quantum computing core is a plurality of quantum structures. A quantum computer is a circuit having one or more computing cores. A quantum fabric is a collection of quantum structures, circuits, or interaction gates arranged in a grid like matrix where any desired signal path can be configured by appropriate configuration of access control gates placed in access paths between qdots and structures that make up the fabric.

In one embodiment, qdots are fabricated in low doped or undoped continuous depleted semiconductor wells. Note that the term ‘continuous’ as used herein is intended to mean a single fabricated well (even though there could be structures on top of them, such as gates, that modulate the local well's behavior) as well as a plurality of abutting contiguous wells fabricated separately or together, and in some cases might apparently look as somewhat discontinuous when ‘drawn’ using a computer aided design (CAD) layout tool.

The term classic or conventional circuitry (as opposed to quantum structures or circuits) is intended to denote conventional semiconductor circuitry used to fabricate transistors (e.g., FET, CMOS, BJT, FinFET, etc.) and integrated circuits using processes well-known in the art.

The term Rabi oscillation is intended to denote the cyclic behavior of a quantum system either with or without the presence of an oscillatory driving field. The cyclic behavior of a quantum system without the presence of an oscillatory driving field is also referred to as occupancy oscillation.

The state of the quantum system is completely described by the wavefunction Ψ, which for a qubit can be described as a vector on a Bloch sphere. For a multi-state system, the Hilbert space which is a unitary state can be used to represent it. Throughout this document, a representation of the state of the quantum system in spherical coordinates of Bloch sphere includes two angles θ and φ. The vector Ψ in spherical coordinates can be described by these two angles. The angle θ is between the vector Ψ and the z-axis and the angle φ is the angle between the projection of the vector on the XY plane and the x-axis. Thus, any position on the sphere is described by these two angles θ and φ. Note that for one qubit Ψ representation is in three dimensions. For multiple qubits Ψ representation is in higher order dimensions.

### Semiconductor Processing

Regarding semiconductor processing, numerous types of semiconductor material exist such as (1) single main atom types, e.g., Silicon (Si), Germanium (Ge), etc., and (2) compound material types, e.g., Silicon-Germanium (SiGe), Indium-Phosphide (InP), Gallium-Arsenide (GaAs), etc.

A semiconductor layer is called intrinsic or undoped if no additional dopant atoms are added to the base semiconductor crystal network. A doped semiconductor layer is doped if other atoms (i.e. dopants) are added to the base semiconductor crystal. The type of layer depends on the concentration of dopant atoms that are added: (1) very low doped semiconductor layers having high resistivity, i.e. n-type denoted by n−− and p-type denoted by p−−, having resistivities above 100 Ohm·cm; (2) low doped semiconductor layers, i.e. p-type denoted with p− and n-type denoted with n−, having resistivities around 10 Ohm·cm; (3) medium doped layers, i.e. p for p-type and n for n-type; (4) high doped layers, i.e. p+ and n+; and (5) very highly doped layers, i.e. p++ and n++.

Note that introducing dopants in a semiconductor crystal likely results in defects that introduce energy traps that capture mobile carriers. Traps are detrimental for semiconductor quantum structures because they capture and interact with the quantum particles resulting in changed states and decoherence of the quantum information. For realizing semiconductor quantum structures undoped semiconductor layers are preferred.

Classic electronic devices use mostly low, medium, high and very highly doped semiconductor layers. Some layers are ultra-highly doped to behave as metals, such as the gate layer.

Semiconductor processing is typically performed on large semiconductor wafers which have a given thickness for mechanical stability. Circuitry is fabricated on a very thin layer on the top of the wafer where the unused thick portion of the wafer is termed the substrate. In a bulk process, devices are fabricated directly in the semiconductor body of the wafer.

An insulating layer (e.g., oxide) isolates from the substrate the devices used to create circuitry. Semiconductor on insulator process, e.g., silicon on insulator (SOI), uses a layer of insulator (e.g., oxide) between the thin top semiconductor layer where devices are realized and the substrate.

To improve circuit performance, the wafer is processed such that the devices are realized on top of an insulator substrate, e.g., semiconductor-on-glass, semiconductor-on-organic material, semiconductor-on-sapphire, etc.

Alternatively, the semiconductor substrate is eliminated and replaced with a nonelectrical conducting material such as a polymer or other material compatible with a semiconductor process (e.g., substrate-replacement processes). Substrate replacement in realizing semiconductor quantum structures significantly reduces or eliminates substrate decoherence.

High resistivity (i.e. very low doped) substrates are the next best substrate choice for semiconductor quantum structures. Although intrinsic substrates are also suitable for semiconductor quantum structures, there are specific limitations that prevent the use of intrinsic substrates.

Thus, in accordance with the invention, semiconductor quantum structures can be realized in (1) bulk processes, (2) SOI processes, (3) substrate replacement processes, or (4) semiconductor on other materials.

Regarding processing, (1) planar processes may be used where layers have predominantly one orientation, i.e. horizontal; and (2) three-dimensional processes (3D) allow layers with both horizontal and vertical orientation, realizing more complex 3D structures. It is appreciated that although layers are shown in the figures as rectangular prisms for simplicity, physically the layers have more complicated structures. For example, corners are often rounded and distortions are present due to the masking process. In depth dimension, layers tend to have a trapezoidal shape instead of the ideal rectangular one. The semiconductor quantum structures of the present invention can be realized in either planar or 3D processes.

In one embodiment, the quantum system of the present invention comprises a quantum dot array having a plurality of semiconductor quantum structures. A silicon-on-insulator (SOI) or fully depleted SOI (FD-SOI) process may be used in which the substrate is low doped (i.e. high resistivity) and is isolated from the quantum device with a buried oxide layer (BOX). This reduces the decoherence of the quantum particle. In one embodiment, the semiconductor quantum device employs tunneling through the local depleted region. In another embodiment, tunneling occurs through the oxide layer between the semiconductor well (low doped or undoped) and a partially overlapping gate and oxide layer. The active layer is isolated using oxide from adjacent structures, e.g., shallow trench isolation (STI), reducing further the quantum particle decoherence.

Note that the substrate may comprise (1) a semiconductor, (2) silicon on insulator (SOI) substrate, where the substrate comprises sapphire, glass, organic material, etc., (3) an insulating substrate replacement, for example, sapphire, glass, organic material, plastic, polymer, etc., or (4) any other insulating material compatible with a semiconductor process.

Note that regardless of the substrate used, the quantum structure must be electrically isolated from the substrate for the structure to operate properly. Otherwise, the quantum particle may escape thus preventing quantum operation of the structure.

Several ways to electrically isolate the quantum structure include: (1) utilizing an SOI or low doped substrate where the oxide layer electrically isolates the quantum structure from the substrate; (2) using substrate replacement such as an insulator material, e.g., polymer, glass, etc.; and (3) using a fixed depletion region, as the quantum particle can tunnel only through a relatively narrow insulating region such as very thin oxide or a thin depletion region. If the depletion region is too wide, the quantum particle is prevented from traveling. Note that this last option can be fabricated using bulk processes.

The quantum operation is controlled by the gate located over the tunneling path that modulates the barrier created by the local depletion region.

### Quantum Computing System

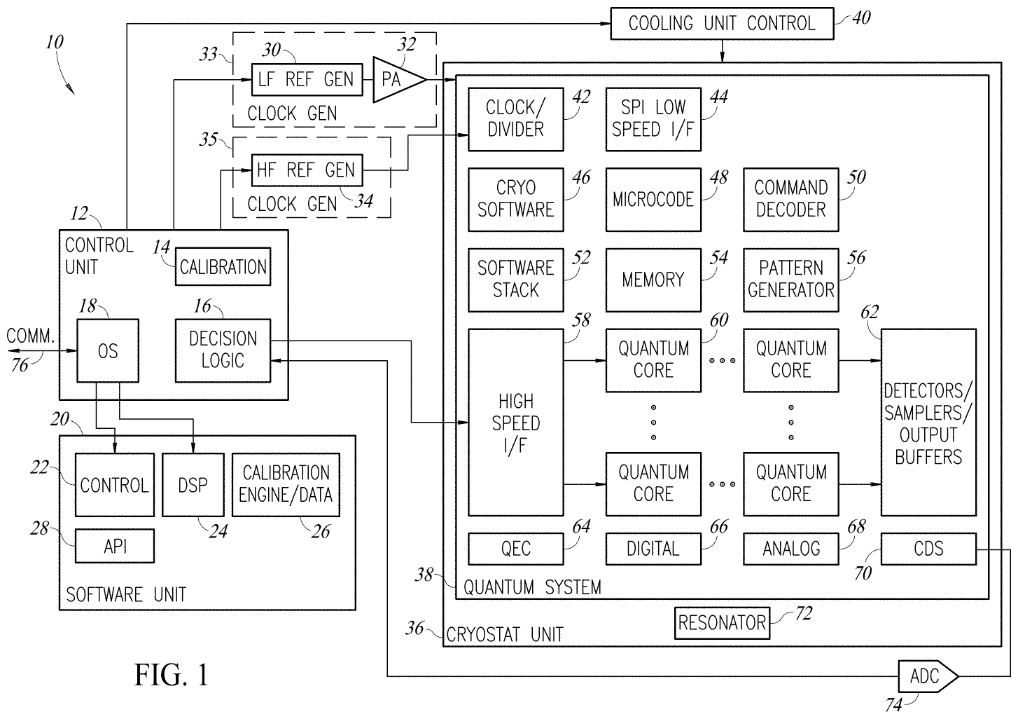

A high-level block diagram illustrating a first example quantum computer system constructed in accordance with the present invention is shown in FIG. 1. The quantum computer, generally referenced 10, comprises a conventional (i.e. not a quantum circuit) external support unit 12, software unit 20, cryostat unit 36, quantum system 38, clock generation units 33, 35, and one or more communication buses between the blocks. The external support unit 12 comprises operating system (OS) 18 coupled to communication network 76 such as LAN, WAN, PAN, etc., decision logic 16, and calibration block 14. Software unit 20 comprises control block 22 and digital signal processor (DSP) 24 blocks in communication with the OS 18, calibration engine/data block 26, and application programming interface (API) 28.

Quantum system 38 comprises a plurality of quantum core circuits 60, high speed interface 58, detectors/samplers/output buffers 62, quantum error correction (QEC) 64, digital block 66, analog block 68, correlated data sampler (CDS) 70 coupled to one or more analog to digital converters (ADCs) 74 as well as one or more digital to analog converters (DACs, not shown), clock/divider/pulse generator circuit 42 coupled to the output of clock generator 35 which comprises high frequency (HF) generator 34. The quantum system 38 further comprises serial peripheral interface (SPI) low speed interface 44, cryostat software block 46, microcode 48, command decoder 50, software stack 52, memory 54, and pattern generator 56. The quantum system 38 can be used to implement the neural network training accelerator of the present invention. The clock generator 33 comprises low frequency (LF) generator 30 and power amplifier (PA) 32, the output of which is input to the quantum system 38. Clock generator 33 also functions to aid in controlling the spin of the quantum particles in the quantum cores 60.

The cryostat unit 36 is the mechanical system that cools the quantum system down to cryogenic temperatures. The deep cryogenic temperatures also help to speed up the digital and mixed-signal circuits while reducing their dynamic and static power (lower leakage). Typically, it is made from metal and it can be fashioned to function as a cavity resonator 72. It is controlled by cooling unit control 40 via the external support unit 12. The cooling unit control 40 functions to set and regulate the temperature of the cryostat unit 36. By configuring the metal cavity appropriately, it is made to resonate at a desired frequency. A clock is then driven via a power amplifier which is used to drive the resonator which creates a magnetic field. This magnetic field can function as an auxiliary magnetic field to aid in controlling one or more quantum structures in the quantum core.

The external support unit/software units may comprise any suitable computing device or platform such as an FPGA/SoC board. In one embodiment, it comprises one or more general purpose CPU cores and optionally one or more special purpose cores (e.g., DSP core, floating point, etc.) that that interact with the software stack that drives the hardware, i.e. the QPU. The one or more general purpose cores execute general purpose opcodes while the special purpose cores execute functions specific to their purpose. Main memory comprises dynamic random access memory (DRAM) or extended data out (EDO) memory, or other types of memory such as ROM, static RAM, flash, and non-volatile static random access memory (NVSRAM), bubble memory, etc. The OS may comprise any suitable OS capable of running on the external support unit and software units, e.g., Windows, MacOS, Linux, QNX, NetBSD, etc. The software stack includes the API, the calibration and management of the data, and all the necessary controls to operate the external support unit itself In one embodiment, the external support unit/software units are adapted to implement the mapping and detection in the classic helper neural networks as described in more detail infra.

The clock generated by the high frequency clock generator 35 is input to the clock divider 42 that functions to generate the signals that drive the quantum system. Low frequency clock signals are also input to and used by the QPU. A slow serial/parallel interface (SPI) 44 functions to handle the control signals to configure the quantum operation in the quantum system. The high speed interface 58 is used to pump data from the classic computer, i.e. the external support unit, to the quantum system. The data that the quantum system operates on is provided by the external support unit.

Non-volatile memory may include various removable/non-removable, volatile/nonvolatile computer storage media, such as hard disk drives that reads from or writes to non-removable, nonvolatile magnetic media, a magnetic disk drive that reads from or writes to a removable, nonvolatile magnetic disk, an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The computer may operate in a networked environment via connections to one or more remote computers. The remote computer may comprise a personal computer (PC), server, router, network PC, peer device or other common network node, or another quantum computer, and typically includes many or all of the elements described supra. Such networking environments are commonplace in offices, enterprise-wide computer networks, intranets and the Internet.

When used in a LAN networking environment, the computer is connected to the LAN via network interface 76. When used in a WAN networking environment, the computer includes a modem or other means for establishing communications over the WAN, such as the Internet. The modem, which may be internal or external, is connected to the system bus via user input interface, or other appropriate mechanism.

Computer program code for carrying out operations of the present invention may be written in any combination of one or more programming languages, including an object oriented programming language such as Java, Smalltalk, C++, C# or the like, conventional procedural programming languages, such as the “C” programming language, and functional programming languages such as Python, Hotlab, Prolog and Lisp, machine code, assembler or any other suitable programming languages.

Also shown in FIG. 1 is the optional data feedback loop between the quantum system 38 and the external support unit 12 provided by the partial quantum data read out. The quantum state is stored in the qubits of the one or more quantum cores 60. The detectors 62 function to measure/collapse/detect some of the qubits and provide a measured signal through appropriate buffering to the output ADC block 74. The resulting digitized signal is sent to the decision logic block 16 of the external support unit 12 which functions to reinject the read out data back into the quantum state through the high speed interface 58 and quantum initialization circuits. In an alternative embodiment, the output of the ADC is fed back to the input of the quantum system.

In one embodiment, the quantum core comprises quantum dots that exhibit a quantum effect, is capable of forming entangled states, and is capable of performing energy optimization. Ultimately, the minimum energy quantum state is read out of the quantum core and used in subsequent processing.

In one embodiment, quantum error correction (QEC) is performed via QEC block 64 to ensure no errors corrupt the read out data that is reinjected into the overall quantum state. Errors may occur in quantum circuits due to noise or inaccuracies similarly to classic circuits. Periodic partial reading of the quantum state function to refresh all the qubits in time such that they maintain their accuracy for relatively long time intervals and allow the complex computations required by a quantum computing machine.

It is appreciated that the architecture disclosed herein can be implemented in numerous types of quantum computing machines. Examples include semiconductor quantum computers, superconducting quantum computers, magnetic resonance quantum computers, optical quantum computers, etc. Further, the qubits used by the quantum computers can have any nature, including charge qubits, spin qubits, hybrid spin-charge qubits, etc.

In one embodiment, the quantum structure disclosed herein is operative to process a single particle at a time. In this case, the particle can be in a state of quantum superposition, i.e. distributed between two or more locations or charge qdots. In an alternative embodiment, the quantum structure processes two or more particles at the same time that have related spins. In such a structure, the entanglement between two or more particles could be realized. Complex quantum computations can be realized with such a quantum interaction gate/structure or circuit.

In alternative embodiments, the quantum structure processes (1) two or more particles at the same time having opposite spin, or (2) two or more particles having opposite spins but in different or alternate operation cycles at different times. In the latter embodiment, detection is performed for each spin type separately.

### Quantum Operation

To aid in understanding the principles of the present invention, a brief explanation of quantum operation is presented below.

As stated supra, in classic electronics, the unit of information is a bit that can represent only one of the two states “0” and “1” at a given time. Computations in classical computers are performed sequentially and every bit can hold only one state at a time.

As stated supra, quantum electronics uses the quantum behavior of particles to perform computations. The unit of quantum information is a quantum bit or qubit. A qubit has two or more base states denoted by \hat{0} and \hat{1} (or |0> and |1>) but in contrast with a classic bit, a qubit can be in a superposed state that contains some percentage ‘a’ of state \hat{0}, and some percentage ‘b’ of state \hat{1}, denoted by a\hat{0}+b\hat{1}. Since a qubit in quantum structures can simultaneously be in multiple superposed states, multiple sets of computations can be performed concurrently, resulting in large quantum computation speed-ups, when compared with classic computations.

A quantum particle is described by its position and/or spin. The particles used in quantum structures are called quantum particles. There are qubits based on the quantum position of the particles, also named charge-qubits, while other qubits use the spin of the quantum particles, also named spin-qubits. In quantum structures, the charge carriers are held in specific regions called quantum dots or qdots. A quantum structure is constructed from one or more qdots.

Performing a quantum computation involves several steps. First the structure needs to be reset, which means that all the free carriers (e.g., electrons or holes) from the structure need to be flushed out. Once the free carriers are removed, the structure is initialized meaning particles are introduced in one of the base states (e.g., \hat{0} or \hat{1}). In the case of a charge-qubit (position-qubit) it means that a carrier is loaded in one of the qdots. A free carrier not coming from the quantum initialization process can interact with the quantum particles and result in decoherence, i.e. loss of quantum information. After the particles have been loaded in the corresponding base states they undergo the desired quantum operation under control of gate control terminals. Once the desired quantum operations are complete a detection is performed whereby the presence or absence of a particle in a given qdot at a given time is tested. Detection is usually destructive which means that the quantum particle's wavefunction and its state collapse. Special nondestructive detection/measurement exist that do not collapse the quantum state. In such cases, multiple measurements of the same quantum state can be performed.

The position of a quantum particle is given by the region where the particle wave-function is mostly present. In one embodiment, quantum structures use semiconductor qdots realized with semiconductor wells where the particle transport is done through tunneling which is a quantum effect. The tunneling or particle transport is controlled by control terminals. In one embodiment, the control terminals are realized using gates but they may comprise other semiconductor process layers.

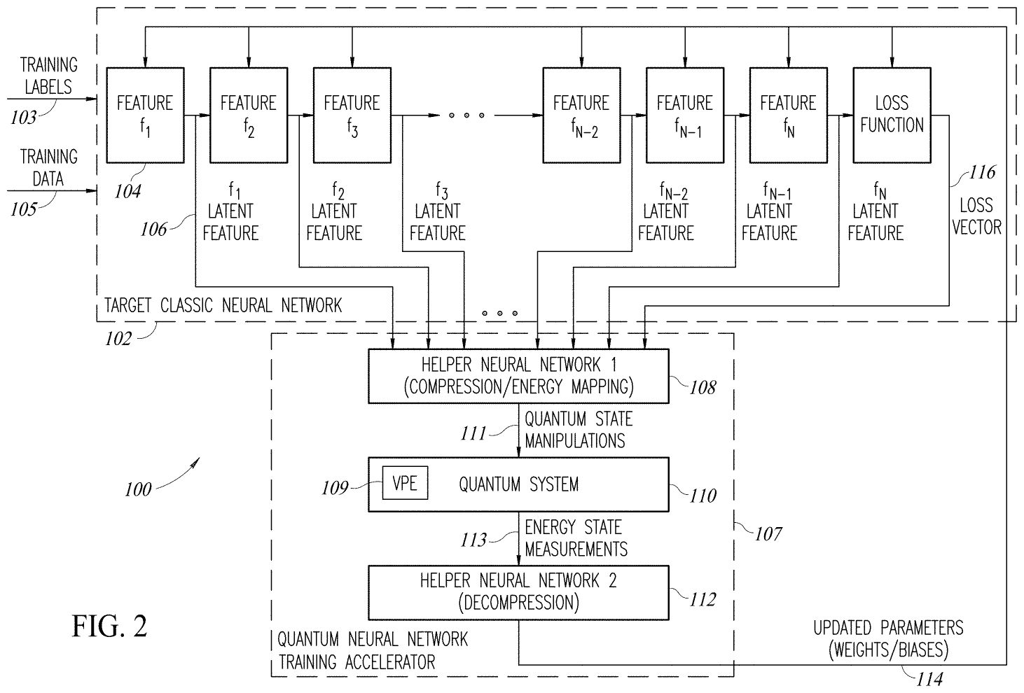

A high level block diagram illustrating a first example quantum accelerated neural network training system is shown in FIG. 2. The system, generally referenced 100, comprises a target classic neural network (NN) 102 and a quantum neural network training accelerator 107 which includes a first classic neural network 108 also referred to as a helper neural network or input neural network, quantum system 110, and second helper classic neural network 112 or output neural network. The classic neural network may comprise a conventional convolutional neural network (CNN) having a plurality of N features 104 with training labels 103 and training data 105 as input. Examples include a CNN, recursive neural network (RNN), perceptron, autoencoder, transformers, etc.

In one embodiment, the two helper NNs are implemented on a classic processor external to the quantum system. In another embodiment, the quantum system 110 may comprise a vector processing engine (VPE) 109 that is operative to implement one or more of the helper neural networks as well as to execute other functions such as feedforward propagation and backpropagation.

In operation, the quantum system implements an optimizer that accelerates training of the classic neural network which is typically built for versatility. Using a suitable training dataset, in the forward pass, the optimum weights/parameters are determined in a single pass or multiple passes depending on implementation. This is achieved by exploiting the properties of the quantum system and manipulating it into a state that represents the complete or partial state of the NN, including the loss function. The quantum system is then allowed to transition to its “optimum state” and the output state of the quantum system is read out from which the optimum parameters for the training data can be inferred (typically from an iterative process involving the evolution of the entire system 100. Note that training coefficients may be ported from one data set to another data set.

The quantum system implements any suitable well-known quantum optimization algorithm. Examples include the optimizers described in N. Moll et al., “Quantum optimization using variational algorithms on near-term quantum devices,” Quantum Sci. Technol. 3 (2018) 030503, https://doi.org/10.1088/2058-9565/aab822; A. Choquette et al., “Quantum-optimal-control-inspired ansätze for variational quantum algorithms,” arXiv:2008.01098v1 [quant-ph] 3 Aug. 2020; and M. Cerezo, “Variational Quantum Algorithms,” arXiv:2012:09265v1 [quant-ph] 16 Dec. 2020, all of which are incorporated herein by reference in their entirety.

The accelerated learning is achieved using first and second helper neural networks 108, 112, respectively, that learn the (1) characteristics of the quantum system structures, (2) the associated quantum states and behavior to an orchestrated series of impulses, and (3) the measured responses to the series of impulses. By running (i.e. in effect, averaging) this over a number of images the learning weight or gradient of descent can be controlled to yield optimum NN parameters. Thus, the system is essentially a nested neural network with the outer NN being the target classic NN and the inner NN being the two helper NNs together with the quantum system.

In operation, the quantum system is manipulated into a state that is representative of the complete classic NN state including the loss function. The quantum system is then allowed to transition to its “optimum state” and the output state of the quantum system is read out to infer the optimum parameters for the training data (e.g., images, video, audio recording, etc.). This is achieved through the helper neural networks that learn the characteristics of the structures, states, and behavior of the quantum system to an orchestrated series of impulses and measured responses. By averaging this over the training data (e.g., a number of images) the learning weights and gradient of descent to optimum parameters can be controlled. Note that the time for the quantum system to reach the optimum state should be shorter than the decoherence time.

Such a system not only solves the problem of long training times for large datasets being repeatedly run, i.e. epochs, but also solves the problem of sparse or small datasets. In addition, with the huge speed up in time the system allows many different deep learning and complex algorithms to be run on the same dataset to find the best algorithm for a specific application. The ability of the system to perform training and converge to optimum NN parameters also drastically reduces the amount of energy and time required for training of large neural networks. It also allows many new data sets and new architectures to be benchmarked in a fraction of cost, energy, and time of traditional NN training.

Note that the quantum system may comprise any suitable system that exhibits a quantum effect, can establish entangled states (although in some cases it is not absolutely necessary), can perform energy optimization (i.e. energy minimization) to find the minimum energy state, can implement variable quantum estimation algorithms, or implement quantum approximate optimization algorithms. Preferably, the quantum system can be well controlled and isolated, straightforward to setup, and straightforward to realize in semiconductors. Examples of quantum systems include noisy intermediate-scale quantum processors (NISQs), quantum dot arrays comprising qubits or qudits, Google quantum computer, IBM quantum computer, IonQ quantum computer, D-Wave quantum annealer, and cesium atoms in an ion trap, as well as a host of other quantum mechanical effects. Note that Josephson junctions may also be used in the quantum system. A Josephson junction is a quantum mechanical device which is made of two superconducting electrodes separated by a barrier (thin insulating tunnel barrier, normal metal, semiconductor, ferromagnet, etc.) such that electrons can tunnel through the barrier.

In essence, the system of the present invention is operative to utilize one or more classic helper neural networks around the quantum system to map an optimization problem such that the minimum energy state is the optimum solution. This enables the quantum system to be used to find the optimal weights and biases for the classic neural network. In some cases, when the capacity of the quantum system is very high or the number of activations and weights is sufficiently low, then no classic helper networks would be required.

In particular, the first helper NN 108 functions to map the activation and loss functions representing the problem to be solved to something that the quantum system can handle. The quantum system is operative to find minimum energy states. The learning system provides a mapping of the learning problem to the minimum energy state problem. This is achieved by first mapping the activation and loss functions to the quantum system's energy characteristics, letting the quantum system find the minimum energy state, and then mapping the output of the quantum system to something that can update the classic NN.

The activation function outputs vectors or tensors 106 from the features f₁ through fₙ as well as the loss function output vector/tensor 116 are input to the first neural network (NN) 108. In one embodiment, the first helper NN performs compression and energy mapping of the activation and loss functions to generate quantum state manipulations 111 that are input to the quantum system 110. In most cases, the activation and loss functions must be compressed to a smaller number of parameters to fit within the quantum system. Neural networks may have thousands, hundreds or thousands, millions or even billions of weights, layers and activation functions. Typical quantum systems currently can handle several, tens or maximum a few hundred qubits or quantum states, and are thus not large enough to handle such an immense inflow of data. Therefore, the activation and loss function outputs are first compressed. The compression step can be performed, for example, using any suitable technique such as the well-known energy based models, e.g., autoencoders, restricted Boltzmann machine (RBM), rule based modeling, and science based modeling (SBM).

After compression, the compressed activation and loss function outputs are then mapped to energy levels in the quantum system. This is achieved by assigning unique spectral frequencies to each of the compressed activation and loss function outputs. The assigned frequency is set in accordance with the magnitude of the activation or loss function output. Based on the assigned frequencies, the pulses driving the quantum system are accordingly generated with specific amplitudes, on/off timings, durations, and frequencies.

The quantum system performs an optimization on the manipulations or energy mapping of the input compressed activation and loss function outputs. One or more energy state measurements are made which are used to generate one or more updated NN parameters 114 that are fed back to the classic NN. The NN parameters may comprise any number of weight and/or bias updates. The second helper NN 112 functions to take the measurement of the energy states and decompress them to generate a larger number of updated NN parameters compared to the number of detector outputs. It is appreciated that although typically the minimum energy state is observable and detected, other energy levels may be observable and detected instead of the minimum energy level.

Note that the first and/or second helper neural networks may be implemented in software on a classic processor like a GPU, FPGA, etc., hardware such as a vector processing engine, or a combination of software and hardware.

An advantage of the system of the present invention is that there is no need to determine the exact frequency and exact pulse length to be used in the quantum system. Since the system exploits the use of the first helper NN to figure out the most optimum choice of frequency of pulse duration to be used. The same applies to the decompression step after the quantum system where the optimum fan out to the weight updates from the detector outputs is chosen by the second helper neural network.

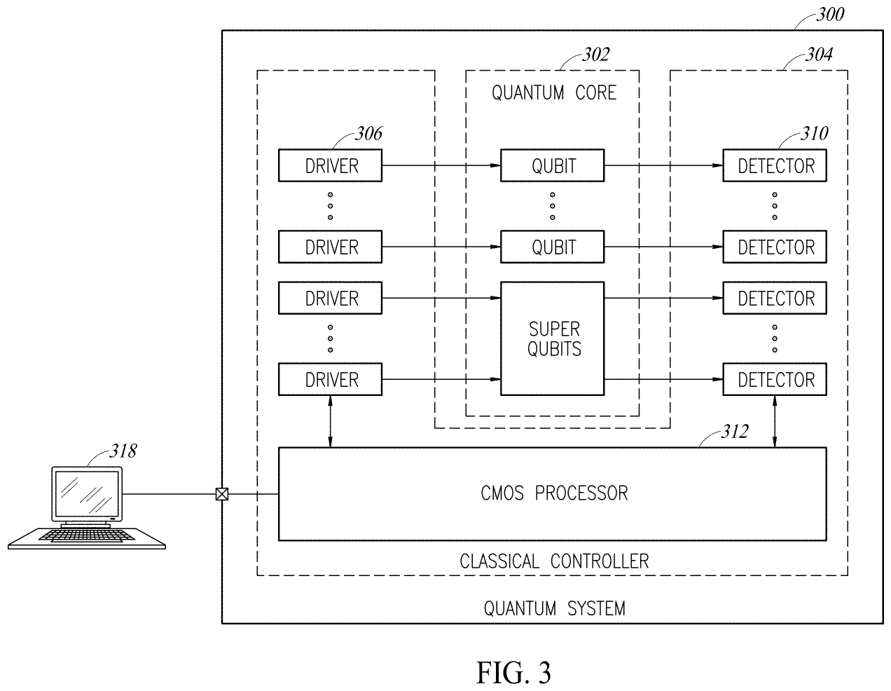

A diagram illustrating a first example quantum system integrated on a single chip is shown in FIG. 3. The quantum system, generally referenced 300, is fabricated on a single chip and comprises a quantum core 302 having a plurality of qubits 308 and a classical controller 304 comprising a plurality of driver circuits 306, detector circuits 310, and complementary metal oxide semiconductor (CMOS) processor 312. The quantum system is typically in communication with another classical processor 318 for administration, configuration, and control.

As an example of advanced CMOS, the 22 nm FDSOI process is capable of providing scalability of qubits. Similar to an integrated circuit (IC) chip, where a single nanometer-scale CMOS transistor can be reliably replicated billions of times to build a large digital processor, a position-based charge qubit structure can be realized as a CMOS compatible coupled quantum system (e.g., quantum dot array (QDA)) in a way that satisfies the manufacturer's design rule check (DRC) with possible minor exceptions signed off by process engineers. The qubit structure is replicated thousands or millions of times to construct a single chip quantum processor operating at 4 K where the cooling requirements are modest.

In one embodiment, the quantum system combines the best features of charge (i.e. high-speed operation) and spin (i.e. long coherence times) qubits in a so called hybrid qubit. Such a hybrid qubit can be controlled electrically without the need for microwave pulses but it requires a solid magnet of 0.5-1 T which can be added to a 4 K cryo chamber. The control and detection of quantum spin states can be based on utilizing the Pauli exclusion principle which dictates that two electrons of the same spin cannot occupy the same quantum dot. The required movement of electrons between quantum dots to try to force them into one quantum dot and the subsequent position detection constitutes the part of charge qubit.

Note that the 22 nm FDSOI process has unique benefits for quantum operation. In contrast to bulk CMOS, FDSOI provides a thin semiconductor layer isolated vertically from the substrate by a 20 nm buried oxide (BOX) layer. Therefore, a quantum particle can be strictly confined inside the 5 nm thin semiconductor film where it precisely follows the gate control and is isolated from the substrate impurities to further increase its decoherence time.

In one embodiment, quantum dots are nanoscopic in size. They are constructed in CMOS using the minimum dimensions that the fabrication process allows. They are small enough to accommodate a single quantum particle, i.e. electron or hole, to hold the quantum information either in its magnetic spin (up or down) or position (being present or absent in a given quantum dot). Note that the underlying principle of quantum dot is a Coulomb blockade by exerting a repulsive force preventing other electrons from joining in and occupying the same space. The key parameter is its capacitance to the background. For a quantum dot of small enough capacitance C, a single electron of charge e entering will decrease the electric voltage potential by observable ΔV=e/C, while presenting the energy barrier of E=e²/2C. For example, an island of a 20 aF capacitance, which can be readily created in CMOS by resorting to a minimum size of the diffusion area, exhibits the single electron charging energy of 4 meV. It is an order of magnitude greater than the thermal energy kT=0.36 meV at T=4.2 K, where k is Boltzmann's constant. This prevents thermally excited electrons from tunneling into the island.

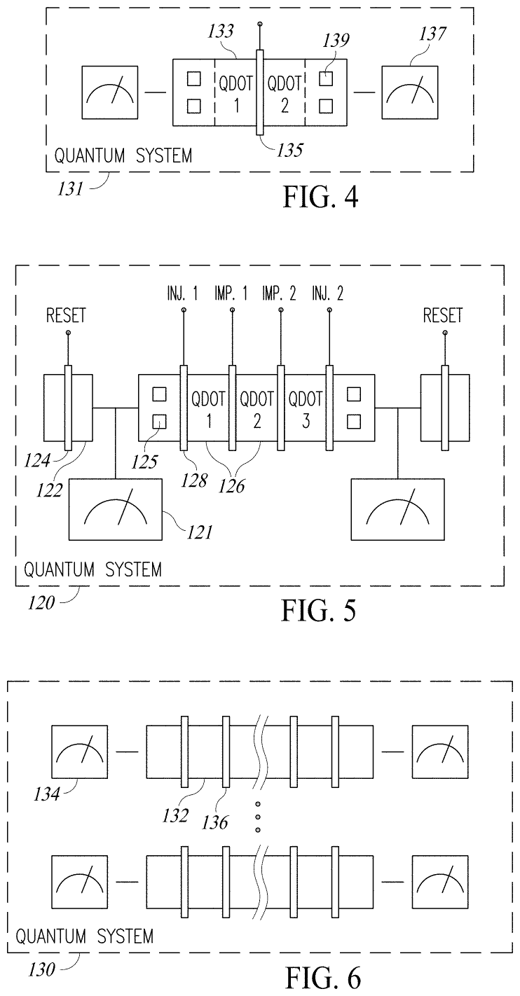

Several example quantum systems will now be described. A diagram illustrating a first example quantum system of two quantum dots is shown in FIG. 4. The quantum system, generally referenced 131, comprises two quantum dots 133 separated by gate 135 (also known as imposer) and having contacts 139. Detectors 137 are connected to both qdots on either or both ends of the structure. Note that the qdots shown in this quantum system and other quantum systems described herein may be fabricated using any suitable process including planar or 3D using tunneling through depletion or tunneling through oxide. Several processes suitable for use in fabricating quantum systems are described in detail in U.S. Pat. No. 10,903,413, entitled “Semiconductor Process Optimized for Quantum Structures,” incorporated herein by reference in its entirety.

A diagram illustrating a second example quantum system of three quantum dots is shown in FIG. 5. The quantum system, generally referenced 120, comprises three quantum dots or qdots 126 forming a quantum dot array (QDA), two classic transistor based reset devices having gate 124 formed over transistor 122 (contacts not shown), two injector devices including gate 128 and contacts 125, two imposers gates forming three qdots 126, and two detector circuits 121 connected on either end of the row of qdots. The qdots may be fabricated using any suitable semiconductor process.

A diagram illustrating a third example quantum system arranged in multiple rows of quantum dots is shown in FIG. 6. The quantum system, generally referenced 130, comprises quantum dot matrix (QDM) comprising a plurality of quantum dot arrays (QDA) where each QDA comprises a rows of qdots. Each QDA row comprises a plurality of qdots 132 separated by gates (imposers) 136 with detectors 134 connected to the ends of each row. Note that the qdots may be fabricated using any suitable semiconductor process.

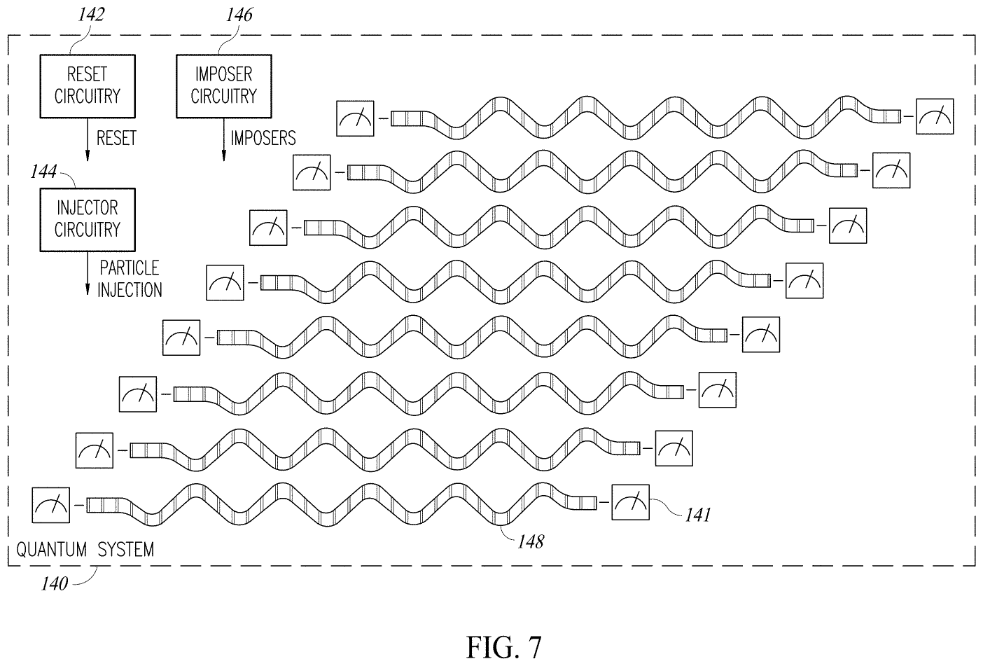

A diagram illustrating a fourth example quantum system arranged in multiple staggered rows of quantum dots is shown in FIG. 7. The quantum system, generally referenced 140, comprises a plurality of rows of qdots arranged in a staggered formation one atop the other. The rows are staggered to meet particular process design rules. Each row includes a linear array of qdots arranged in alternating upright and inverse ‘V’ configurations. This provides close interaction between several qdots in neighboring rows. The quantum system also comprises reset circuity 142 operative to reset qdots to an initial state, injector circuitry 144 operative to inject one or more particles (e.g., electrons, holes, etc.) into each row, imposer circuity 146 operative to control and manipulate the qdots in each row, and detector circuits 141 connected to the qdots on either end of each row. Note that the qdots may be fabricated using any suitable semiconductor process.

It is appreciated that quantum systems, such as quantum dot arrays or matrices, having an appropriate size may be used with the accelerated training mechanism of the present invention. The size of the quantum system is bound, however, by the constraints of the current state of semiconductor process technology that can support the quantum properties at the expected quality level.

In addition, in one embodiment, the quantum system comprises one or more redundant rows that are reserved as replacements to be used in the event of a failure of one of the rows. One or more individual redundant quantum dots may also be provided to be used in the event of a failure of the quantum dots.

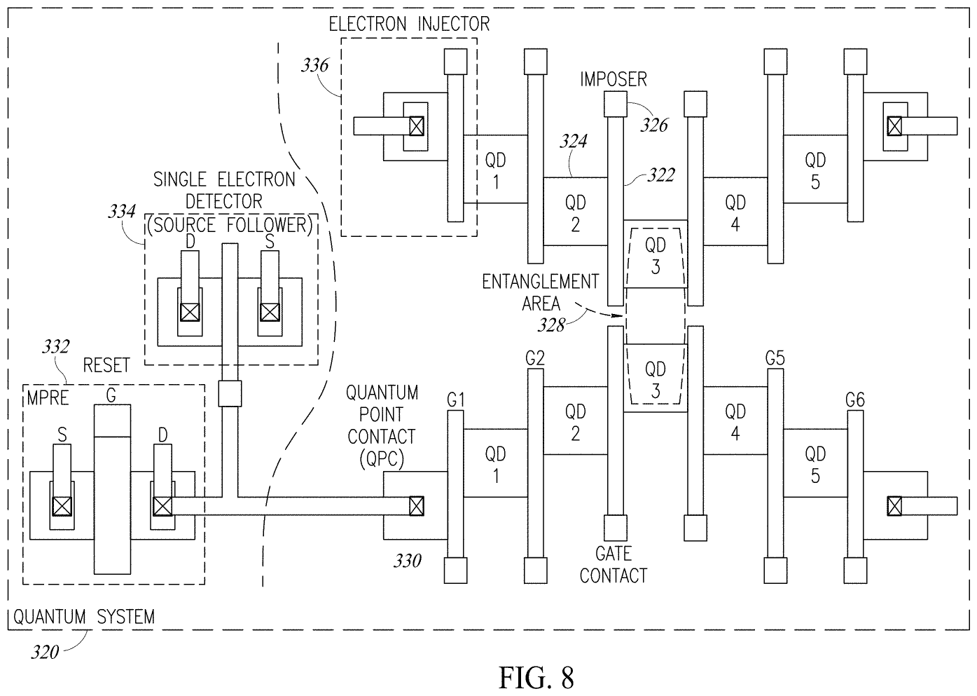

A diagram illustrating a sixth example quantum system arranged in a double ‘V’ shaped array of quantum dots is shown in FIG. 8. The quantum system, generally referenced 320, was realized in 22 nm FDSOI. It comprises two rows of arrays of seven quantum dots (QD) 324 where each row includes imposers having gates 322 and contacts 326. Each quantum dot is roughly 80×80 nm² in size, which is the minimum allowed by the process rules. The middle of each quantum dot array (QDA) is a staging area for entanglement 328. The quantum system also comprises a reset circuit 332, single electron detector circuit 334, and electron injector circuit 336. The parasitic capacitance at the quantum point contact (QPC) node 330 is minimized to increase the voltage swing due to the arrival/departure of one electron.

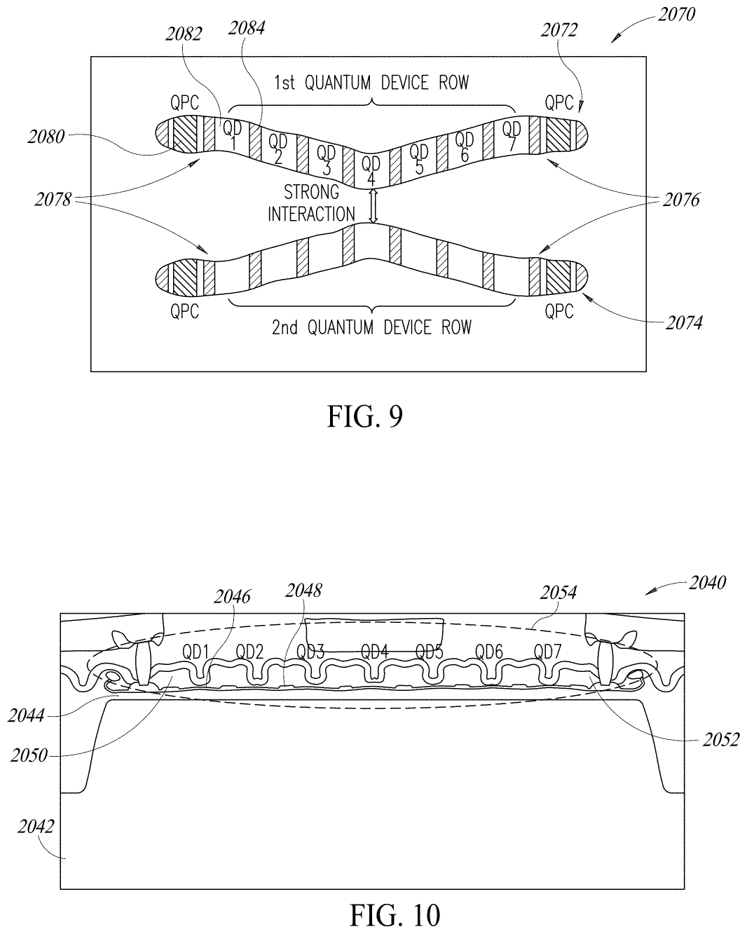

A diagram illustrating a top view of a double V shaped quantum structure of FIG. 8 with multiple quantum dots, injector and extractor interface devices is shown in FIG. 9. The example structure, generally referenced 2070, comprises a first upper quantum device row 2072 and a second lower quantum device row 2074. Each quantum device row comprises left injector/detector interface devices 2078 and right injector/detector interface devices 2076. The four relatively wide dark bands 2080 represent the raised source/drain diffusion regions in each of the four interface devices. Seven qdots 2082 are formed on either side of the gates 2084 in the upper and lower quantum device row. Note that this top level view of the double ‘V’ shaped structure is a photograph of a real world quantum structure constructed in accordance with the invention.

A diagram illustrating a cross section of the array of FIG. 8 with multiple quantum dots, injector and extractor interface devices is shown in FIG. 10. The example quantum structure, generally referenced 2040, comprises a substrate 2042, oxide (BOX) layer 2044 providing electrical isolation from the substrate, thin undoped silicon layer (i.e. active) 2046, and gate oxide 2048. An injector interface device 2050 on the left side functions to inject quantum particles (e.g., electrons) into the quantum path 2054. Detector interface device 2052 on the right side functions to detect the particle after the quantum interaction. The detector and injector, however, can both be connected to both the left and right end of the structure. They use the same structure and their operation can be time shared. The interface device (overlapped with 2050) comprises a raised diffusion source/drain, contact (CA), and metal (M1), and dummy gate.

The quantum devices comprise a gate surrounded on both sides by qdots. The gate is fabricated from the silicon dioxide layer 2048 over the active layer 2046, silicide layer on top of the silicon dioxide layer, and polysilicon and nitride layers over the silicide layer. In this example structure, seven qdots are shown, namely QD1 through QD7.

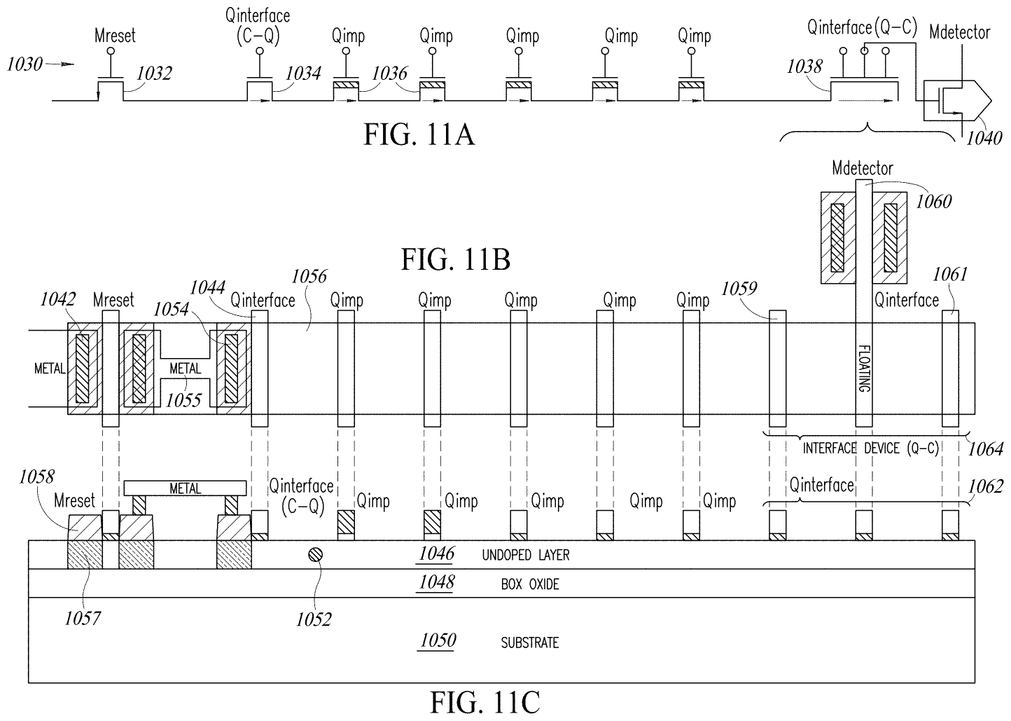

Detection of particles (i.e. minimum energy states) can be either demolition (i.e. destructive, involving collapse of the quantum particle's wave function) or non-demolition (i.e. non-destructive). Non-demolition detection of quantum states uses a floating gate. In this case the classic device of the detector Mdetector is connected to the same floating gate that goes over the quantum well. An equivalent schematic of the quantum circuit, generally referenced 1030, together with its associated interface and classic circuits is shown in FIG. 11A. A top plan layout view of the circuit is shown in FIG. 11B and a cross section of the circuit is shown in FIG. 11C. The quantum circuit 1030 comprises several layers including substrate 1050, BOX oxide 1048, and undoped fully depleted layer 1046. Doped regions 1058 are fabricated over the fully depleted layer, which can result in some dopant diffusion into region 1057.

Similar to the floating well detection circuit 990 described supra, the quantum procedure starts with the reset of the structure 1030 using one or more classic Mreset devices 1032 along with appropriate control of the interface quantum gates (Qinterface) 1034 and imposer quantum gates (Qimp) 1036 such that all or almost all free carriers in the quantum structure are flushed out. The classic to quantum Qinterface device 1034, operative to inject a single carrier 1052 into the quantum structure, has a half-classic and half-quantum operation. It comprises a doped and metal contacted classic well 1054 on the left side of its gate 1044 and a floating quantum well 1056 on the other side. In one embodiment, the connection between the Mreset and Qinterface devices on the classic side is realized with contacts and metal layers 1055. Note that the Mreset and Qinterface devices may share the same active layer or may be done in separate active layers.

The quantum imposer (Qimp) devices 1036 determine the specific quantum computation performed. There is at least one Qimp quantum control gate. Alternatively, the circuit may comprise any number of Qimp devices as large as feasible in the actual implementation using a given semiconductor process.

The last three gates over the quantum well on the right side of the circuit 1030 form a quantum to classic Qinterface device 1038, 1064, 1062. Note that alternatively, the Qinterface device may be located in the middle of a quantum well. One of the three gates (1060) is the floating gate which connects to the Mdetector classic detector device 1040. In one embodiment, the carrier is moved under the floating gate by controlling the potential distribution with the two adjacent gates 1059, 1061. The presence of the quantum carrier under the floating gate causes a small change of the potential of the quantum gate which is sensed by the Mdetector detector device 1040 and amplified further.

After the first measurement is performed, the quantum carrier can be moved away from under the floating gate 1060 of the interface device. The floating gate initial potential is set during the reset time to a level that allows the proper operation of the Mdetector classic detector device. Such potential may be reset for example with a second classic Mreset device (not shown) connected to the gate of the Mdetector device.

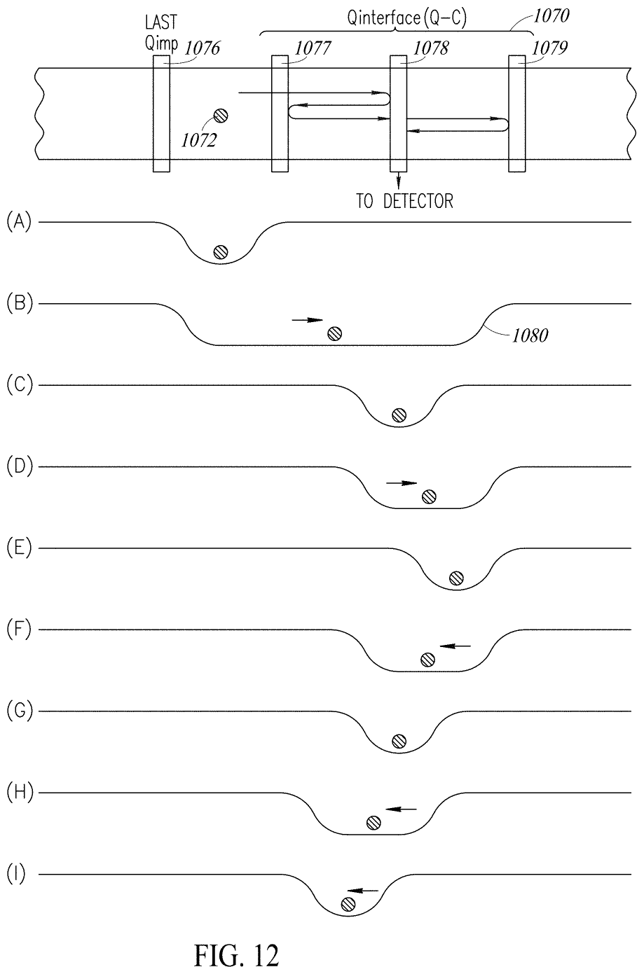

An example potential diagram for the floating gate detection circuit is shown in FIG. 12. The last quantum imposer gate Qimp 1076 together with the three gates 1077, 1078, 1079 of the quantum to classic interface device (Qinterface) 1070 are shown. In this example, two ‘helper’ gates (left gate 1077 and right gate 1079) are controlled and not floating while only the middle gate 1078 is floating and used for actual detection. The middle floating gate 1078 is connected to the detector circuit 1040 (FIG. 11A). It is appreciated that the Qinterface device may comprise more or less than three gates. For example, the detection can be performed using only two interface device gates, i.e. one floating and one controlled.

In operation, the particle is moved one or more times under the floating gate to perform detection (i.e. nondestructive measurement or observation). Multiple measurements are performed under the detection gate for the same quantum experiment. A measurement is made each time the particle moves under the floating gate 1078. Note that the movement is speculative in nature since it is not known a priori whether there is a particle present or not as this is what is being measured. If no particle is detected, then of course most likely no movement actually takes place.

With floating gate detection, a gate overlaps the last region of a quantum well where the presence of a particle is to be detected. Note that the potential of the floating well can be set initially, for example during the reset process, to a reference value appropriate for the detector circuitry. It should, however, be subsequently allowed to be floating such that it can sense the presence or absence of a particle under it, e.g., carrier, electron, hole, etc.

In the floating gate detection process the particle represented by the quantum state or qubit is allowed to move under the floating gate. If a particle is present then the potential of the gate changes from the reference potential it was initially set to, while the particle is not present then the potential of the gate does not change due to the quantum state moving under the gate.

Note that in idealized circuits there are no parasitic leakage currents and the potential of a floating gate can remain for relatively long periods, ideally to infinity or until it is again reset to the potential it achieved at the end of processing. In real circuits, however, parasitic leakage currents typically exist (e.g., a gate over a well may have a certain leakage current from the gate to the well). Such current changes the potential of the floating gate independent of the presence or absence of the quantum particle.

To prevent such floating gate potential change due to leakage, numerous well-known circuit techniques can be applied, including performing the detection quickly such that there is not enough time for the floating gate potential to change significantly due to leakage. In this case the significant potential change is a fraction of the potential change determined by the presence of the quantum particle, e.g., 10% or 20%. Another technique is to use a replica floating gate that never gets a quantum particle but has a similar leakage current with the detection floating gate. By measuring the differential signal between the detection floating gate and the replica floating gate, the voltage change due only to the presence or absence of the quantum particle can be detected, while any parasitic voltage change due to leakage current is rejected as a common mode signal.

In one embodiment, the actual operation of the floating gate detection consists in modifying the potential in the proximity of the floating gate such that the quantum particle is moved in a controlled fashion under the floating gate and then away from it.

Since the coupling to the detector is weak and the quantum particle can be moved multiple times under the floating gate and then away from it, this detection is largely non-destructive and can be performed multiple times. By performing the detection multiple times any parasitic effect due to inherent noise in the system is eliminated or attenuated. Note that the number of consecutive non-destructive detections that can be performed, however, depends on the decoherence time of the quantum state in the given process technology and given physical structure.

With reference to FIG. 12, to impact the potential around the floating gate and thus allow the quantum particle to move under the floating gate and then away, multiple additional helper control gates are used. In one embodiment, a single helper control gate is used located on one side of the main floating detection gate. In another embodiment, two helper control gates are used, one on each side of the main detection floating gate, as shown. Alternatively, additional helper control gates can be placed around the main detection floating gate. The further away the helper gate is placed, however, the less impact it has on the potential profile around the detection floating gate. This is why the most effective are the helper gates directly to the left and right of the main detection gate.

A quantum structure includes a number of control gates, also called imposers that determine the specific quantum operation performed. After the last imposer has performed its function, the desired quantum computation has finished and the quantum state is ready for detection.

In position based semiconductor quantum structures the detection entails determining whether or not the particle is present in the last quantum dot of the structure, past the last imposer. If the quantum state is one of the base states, i.e. particle present or absent, then the detection can be done only once (in the absence of system noise). When noise is present, multiple detections may be desired to reject or attenuate the impact of the system noise.

If the quantum state is a general superposed state, the particle has a certain probability of being present in the last detection quantum dot. To measure the quantum state, the detection is performed multiple times. The percentage of positive (i.e. present) outcomes versus the total number of measurements represents the probability corresponding to the measurement of the corresponding quantum state. Similarly, the percentage of negative (i.e. absent) outcomes may be used.

In trace (A) the control signals on the left and right helper control gates are such that the potential energy profile is high and the quantum particle is not allowed to move towards the floating detection gate. The particles flow towards the positions with lower potential energy. If a voltage potential profile is drawn instead, the electrons go to higher potential level locations. The situation is reversed for the holes that go to the regions of higher energy. From the voltage potential perspective, the holes go to the lower potential levels.

Trace (B) illustrates the case when the control signals on the left and right helper control gates are modified such that the energy profile level is lowered (1080) in the area surrounding the floating detection gate. This allows the quantum particle to extend over the entire physical location where the energy profile is low. This also includes the region under the floating detection gate.

Trace (C) shows the control signals of the left and right helper control gates changed such that the region of low energy profile is restricted to a narrow region essentially under the floating detection gate. Now the quantum particle is localized in a very narrow region under the floating detection gate. This results in a relatively large (i.e. measurable) change in the potential of the floating gate. When the quantum particle is distributed over a wide area, the change in potential is much smaller, making it harder to measure. Having the particle located directly under the floating gate generates a change in potential of the floating gate which can be measured and amplified by the Mdetector circuit 1040 (FIG. 11A) using one or multiple classic FET devices.

The quantum particle is then moved away from the floating detection gate. As shown in trace (D), first the right helper control gate is used to enlarge the area of low energy towards the right side, away from the floating detection gate. In this case the energy profile is still low under the floating detection gate which allows the quantum particle to spread both under the floating gate and away from the floating gate.

In a second step as shown in trace (E), the helper control gates are used to raise the energy profile in close proximity of the floating detection gate, allowing the quantum particle to extend away from the floating detection gate. In this manner, the quantum particle is moved away from the floating gate and the first detection has ended. The quantum state is still intact. It has not been destroyed (collapsed) through the first detection. A second detection may be performed by moving the quantum particle under the floating detection gate again.

Trace (F) shows how the control signals on the two helper control gates are again enlarging the region with low energy profile, allowing the quantum particle to move again under the floating detection gate. The low energy level area remains wide and the quantum particle is spread both under the floating detection gate and away from the floating gate. As such the change in potential of the detection gate is low and harder to measure.

In trace (G) the control signals on the helper control gates again determine the narrowing of the energy valley where the quantum particle is allowed to spread to a relatively narrow region under the main floating detection gate. As such the quantum particle moves a second time under the gate and a second non-destructive quantum detection is performed.

The detection process can continue with multiple subsequent detections. In trace (H) the helper control gates are used to again widen the low energy level where the quantum particle is present. In this way the quantum particle is spread under and away from the floating detection gate.

In trace (I) the helper control gates restrict the area of low energy level where the quantum particle can be present to a region away from the floating detection gate.

In this manner, the process can continue with further subsequent movements of the quantum particle under the floating detection gate and away from the floating detection gate, both on the left side and on the right side.

A key advantage of floating gate detection is that it allows multiple detection of the same quantum state, without the need of repeating the entire quantum computation since the particle's wavefunction does not substantially collapse in the detection process. Therefore, instead of performing the entire quantum experiment multiple times, the quantum experiment is performed once but the results are measured multiple times. This shortens the overall computation time thus increasing the speed of quantum computation, and thus provides accelerated quantum computation.

In the case of the destructive floating well detection, the quantum particle “quantumness” is lost with each detection. Thus, performing multiple floating well detections require multiple executions of the entire quantum operation, which in turn takes a longer time. The more time spent on detection reduces the speed of quantum operation and thus reduces the effective quantum acceleration factor with respect to a classical computation.

In another embodiment, the floating gate detection may be followed by a floating well detection which finally collapses the quantum state. By using both methods of detection, a more sophisticated detection scheme can be built with lower error rate. By looking at the correlation between the two types of detection, built-in detection error correction can be realized.

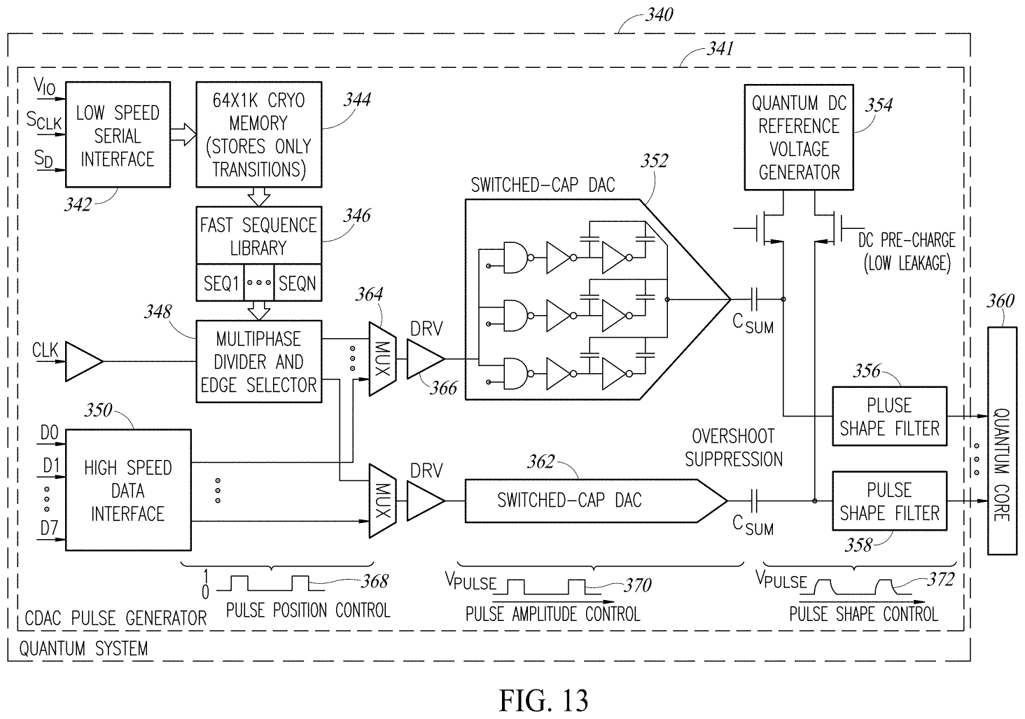

A high level block diagram illustrating an example capacitive DAC based pulse generator coupled to the quantum core is shown in FIG. 13. The quantum system, generally referenced 340, comprises a capacitive digital to analog converter (CDAC) pulse generator circuit 341 coupled to a quantum core 360 comprises a plurality of qubits. The CDAC) pulse generator circuit comprises low speed serial I/F 342, cyro memory 344, fast sequence library 346, high speed data interface 350, multiphase divider and edge selector 348 that receives a clock and whose outputs feed switched capacitor DACs 352 via multiplexers 364 and drivers 366, quantum DC reference voltage generator 354, and pulse shape filter 356 that outputs the pulses to the quantum core 360. Waveforms 368, 370, 372 show the pulse position control, pulse amplitude control, and pulse shape control, respectively.

In contrast to the conventional creation of quantum dots entirely through process lithography, the quantum dots of the present invention are defined mainly by the applied voltage potentials at the imposers. Since the control voltages can be precisely set in time and amplitude, the depths of the quantum wells and the tunneling between them can precisely control the movement of individual electrons and their mutual entanglement for the intended quantum operation.

It is noted that the load presented by the QDA is capacitive and is relatively light. Hence, the driving circuits in FIG. 13 are able to dissipate power in the range of tens of microwatts and still operate at the gigahertz rate while providing precisely controlled voltage levels and pulses of ultralow amplitude noise. Note that the tunneling rate is exponentially related to the imposer's voltage.

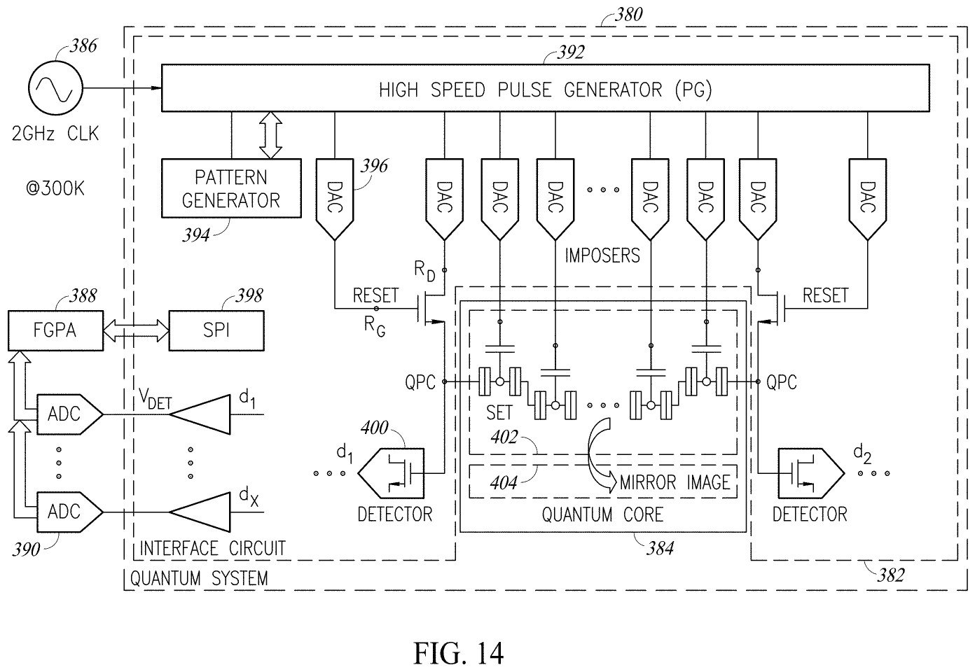

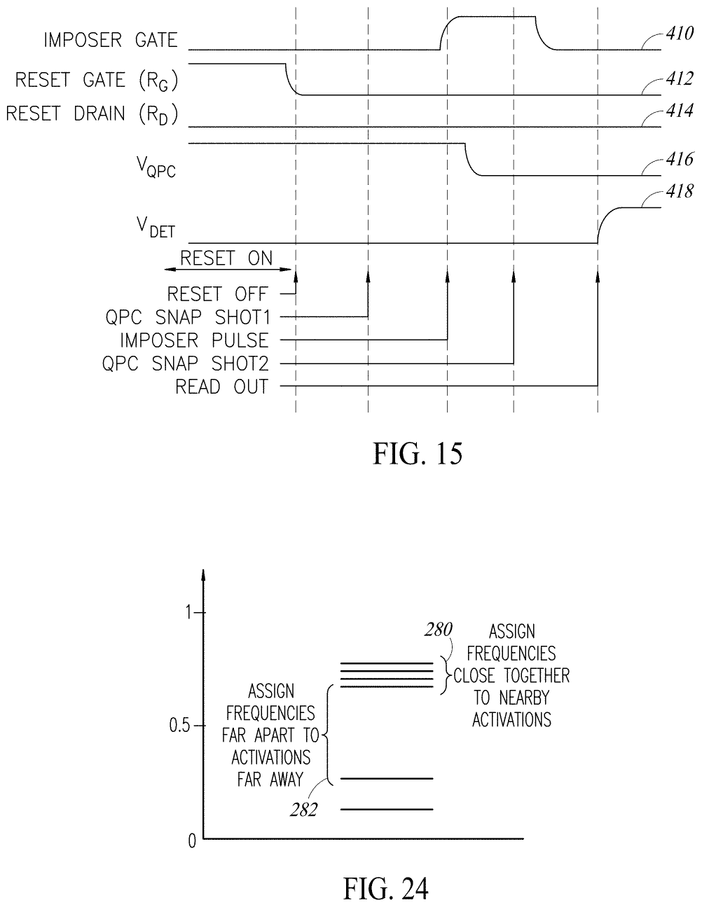

A high level block diagram illustrating an example quantum core interface circuit is shown in FIG. 14. A timing diagram of the signals of the quantum core interface circuit of FIG. 14 is shown in FIG. 15. With reference to FIGS. 14 and 15, the quantum system, generally referenced 380, comprises interface circuit 382 and quantum core 384. The interface circuit 382 provides reset, control, single-electron injector and detection. The quantum core comprises a double ‘V’ shaped QDA of quantum dots shown as single electron transistors (SETs) (only one ‘V” is shown for clarity with the other being a mirror image). The quantum dots in the quantum core are controlled by imposers whereby a plurality of CDACs 396 function to generate precise pulses via pulse generator 392 driven by clock source 386 and pattern generator 394 to control the operation of the quantum core. The CDACs are operative to generate reset pulses, single electron injection signals, as well as imposer signals. Detector circuits 400 measure the presence or absence of an electron on either end of the QDA. The quantum system communicates with external field programmable gate array (FPGA) 388 via serial peripheral interface (SPI) 398. Output from the detectors 400 is fed to external analog to digital converters (ADCs) 390 via a plurality of drivers.

It is noted that the quantum core is cooled to approximately 4 K while the interface circuitry may be at the same or higher temperature. The circuitry external to the quantum system is at room temperature (i.e. 300 K).

The CDACs control the precise amplitude and timing of the pulses for (1) the reset operation (R_{D} and R_{G} signals) to ensure the QPC node is free from extra electrons; (2) single-electron injection into the first quantum dot; and (3) imposers to transfer electrons between the quantum dots. The example waveforms shown include the imposer gate 410, R_{D} and R_{G} signals 412, 414, respectively, voltage V_{QPC} on the QPC 416, and detector voltage V_{DET} 418.

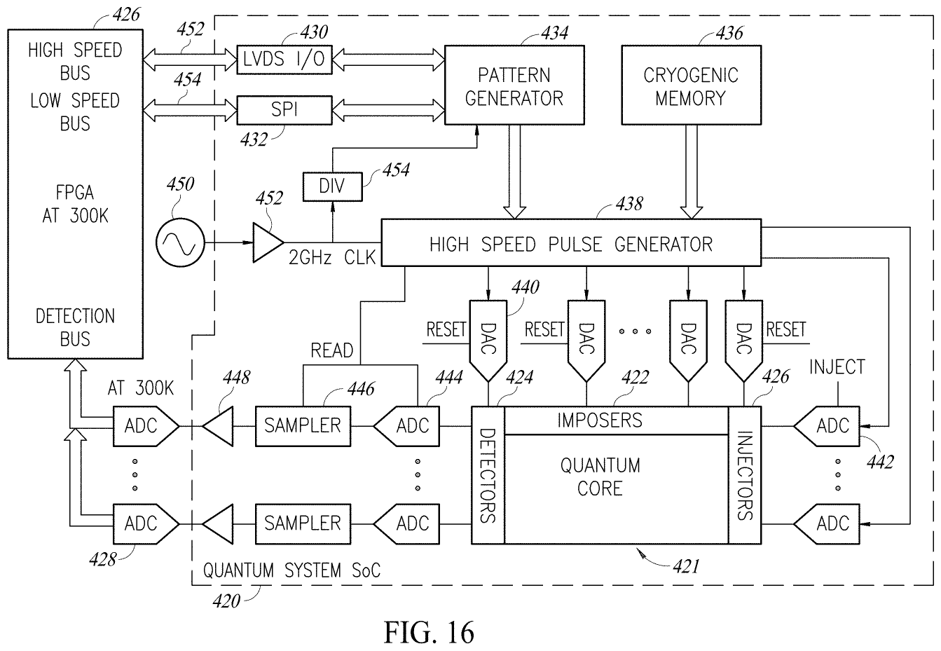

A high level top block diagram illustrating an example quantum system on chip (SoC) is shown in FIG. 16. The quantum system, generally referenced 420, comprises quantum core 421 having injectors 426, imposers 422, and detectors 424 controlled by a plurality of CDACs 440, 442 that receive digital signals from pulse generator 438. Data from an external FPGA 426 is transferred over buses 452, 454 to pattern generator 434 via low voltage differential signaling (LVDS) I/O circuit 430, SPI 432, respectively. Output from detectors 444 are sampled by samplers 446 and fed to the external FPGA via drivers 448 and ADCs 428. High speed pulse generator 438 is driven by clock source 450 and driver 452. Divider 454 feeds a divided clock to the pattern generator.

In one embodiment, the quantum SoC is realized in 22 nm FDSOI and operates at 4 K. A 2-6 GHz external clock 450 is buffered and divided down to create a multi-phase system, while the pattern generator core 434 determines the selection of the appropriate clock edges to create the fast and narrow pulses needed to control the quantum structures in the quantum core. The pulse generator 438 provides high resolution pulse width control, while CDACs 440 provide a high resolution amplitude setting for the quantum control pulses. The pulse amplitude sets the Rabi oscillation frequency in the semiconductor quantum structures, while the pulse width determines the particular quantum operation performed, such as quantum CNOT, quantum rotation, Hadamard split, etc. The quantum detectors 444 are followed by correlated double samplers (CDS) 446 that provide first-order correlated noise rejection. After further amplification 448 and analog-to-digital conversion 428, the detected signals are sent to the FPGA board 426. Individual per qubit calibration loops are used to set the appropriate pulse amplitude and width levels for each local quantum structure. This compensates for the CMOS process variation impact on the quantum performance of each qubit.

A diagram illustrating the potential energy as a function of distance for the three quantum dot system of FIG. 5 is shown in FIG. 17. A rough potential energy profile 152 using a piecewise linear approximation is shown as well as a more precise potential energy profile 150, obtained for example from a finite element method (FEM) simulation. The energy profile represents the potential energy level that can act on a quantum particle (e.g., electron) and is established from the internal energy work function for the silicon material as well as imposer voltages and it is different from the kinetic energy of the particle (e.g., electron). The horizontal lines 154 represent discrete energy levels, i.e. energy solutions to the electron's wave functions, which the electron can take on. As shown, the energy barriers between the qdots under the gate are relatively high. The potential that adjusts the energy barriers is controlled by the imposer gates. The potential wells at lower energy levels lie between the gates. In operation, the electron can tunnel from one qdot to another and can go back and forth through the potential barriers if they are not too high. Notwithstanding wave-particle dualism of the electron, in this case, the electron is described as a wave and can exist in multiple positions simultaneously. The wave function for the electron is a complex function whose Schrodinger equation solutions are eigenfunctions. It is appreciated that small changes to the gate potential results in large changes on the wave functions.

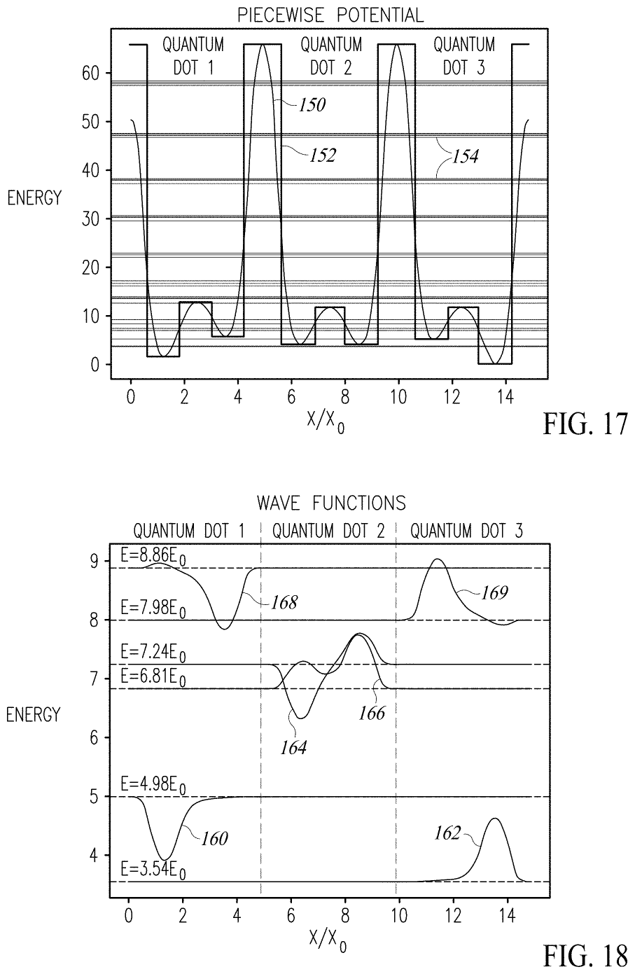

A diagram illustrating the wave functions (real part of the complex value) as a function of position for the three quantum dot system of FIG. 5 is shown in FIG. 18. For the case of the three qdots, solving the Schrodinger equation for the potential energy yields the six wave functions 160, 162, 164, 166, 168, 169, which are conveniently raised to the level of the corresponding energy. The probability of every position of the electron corresponds to the absolute square of the wavefunction value, whereby the electron can be in multiple positions at the same time. In operation, one or more electrons are injected into the QDA 120 (FIG. 5) such that the electron will be partially in multiple locations at the same time (i.e. distributed wave function). The Rabi oscillation frequency is proportional to the energy difference between two energy levels with a proportionality factor of the Planck constant inverse. A key feature of the quantum system is that it can be in multiple energy states at the same time. Measurement entails looking for the partial population of the lowest energy level what is the energy level connected to the detector.

Note that multiple energy levels can be mapped using quantum tomography techniques. After the electrons are distributed to the various energy levels and interactions occur, multiple measurements are performed where the lowest energy level in each iteration is read out. Microwave radiation (i.e. photons) is applied to force transition of electrons from higher energy levels to the lowest energy levels which are then read out. This is repeated over all energy levels to yield a full mapping of the quantum system. Mathematically, the well-known unitary swap operation can be used to perform the quantum tomography. In one embodiment, a floating gate detector performs a non-demolition measurement.

Once an electron is injected into the quantum system at a particular energy level, further application of energy will move the electron to a different energy level, which could be higher or lower depending on the duration in accordance with the Rabi oscillation. For example, consider an electron injected into the quantum system into a known energy level such as the lowest level wavefunction 162 corresponding to 3.54E₀. A delta energy pulse in the form of a photon for example is applied. The frequency and duration of the delta energy pulse corresponds to the transition from 3.54E₀ to 4.98E₀. As a result, the electron's wavefunction will transition to 160 corresponding to energy level 4.98E₀. Note that the transition from one energy level to another does not have to be 100%. In other words, the electron can be at both energy levels at the same time in some proportion, e.g., 25-75, 50-50, etc., depending on the duration of the delta energy pulse applied. The energy levels correspond to their associated eigenfunctions which are solutions to the Schrodinger equation. They correspond to actual position probabilities of finding the electron(s) in the system. Every energy level is associated with a different distribution of electron positions. Considering that there is only one lowest energy state, the mechanism of the present invention is operative to map an optimization problem (i.e. finding the best weights in a NN) to the problem of finding that lowest energy level. Thus, the invention is capable of finding optimum solutions to problems as long as the optimal result is represented by the lowest energy level.

Note that a characteristic of quantum systems that enable them to be good optimizers is that they have reversable logic. Quantum systems logic is reversable whereby the input state is generated by providing the logic and output state.

In one embodiment, the delta energy pulse comprises an RF field or pulse (e.g., microwave photons, visible or invisible light) that is radiated from an antenna on or off chip. The microwave photons interact with the quantum system, which is governed by the well-known photo-optical effect dictated by the Planck-Einstein relation E=hf, where E is energy, h is Planck's constant, and f is frequency of the photon. The energy difference between the two levels determines the frequency which is typically in the high megahertz to low gigahertz range. Knowing the energy difference enables the calculation of the exact frequency of the photon. In reality, the photon and electron in the quantum system can be entangled. The photon interacts with the position of the electron. By ‘shining’ the photon onto the electron, the position of the electron changes (i.e. changes energy levels). By creating the photons which are quanta of electromagnetic energy at the particular frequency, then sufficient energy can be pumped into the system to transport the electron between energy levels. Thus, the photon frequency corresponds to an energy level change and vice versa.

Although the entanglement is basically between the photon and the electron, different photons may entangle as well. If a first photon of a first frequency or ‘color’ is applied it will have a dependency on what happened with a different photon having a different ‘color’. The resulting electron state is an interaction between the first and second photons which are entangled because they were communicating across the same electron.

Every activation level applies its own photon having a unique ‘color’ into the electron.

The resulting position of the electron is read out but is a function of all the photons applied to the system multiplied in a non-communicative manner. If the sequence of photons applied is merely changed, the result is a different set of outputs.

Depending on the duration of the application of the frequency all or a portion of the electron (actually, a portion of the wavefunction) is transferred to the higher energy level. If the light continues to be applied at the frequency corresponding to the particular energy difference between wavefunctions 160 and 162, then a periodic oscillation between the electron being in wavefunctions 160 and 162.

Thus, radiating into the quantum system a frequency that corresponds to the energy difference between two energy levels will cause the electron to be transported from one energy level to another. The frequency, however, must be fairly precise and correspond to the particular energy transition. If the frequency does not match the distance between the levels (i.e. not substantially at the required frequency), the electron will not be transported between levels.

Note that in this embodiment the detectors are connected to the outer qdots only and thus can only detect the energy level of a portion of the wavefunctions. For example, the detector connected to the left outer qdot can detect the electron in wavefunctions 160 and 168 (to a somewhat lesser degree). The detector connected to the right outer qdot can detect the electron in wavefunctions 162 and 169. Neither left nor right detector can detect the electron if it is in wavefunctions 164 or 166 (to a somewhat lesser degree).

It is appreciated that changing the voltage levels applied to the gates of the QDA causes changes to the potential barriers which will alter the energy levels and thus the corresponding frequencies.

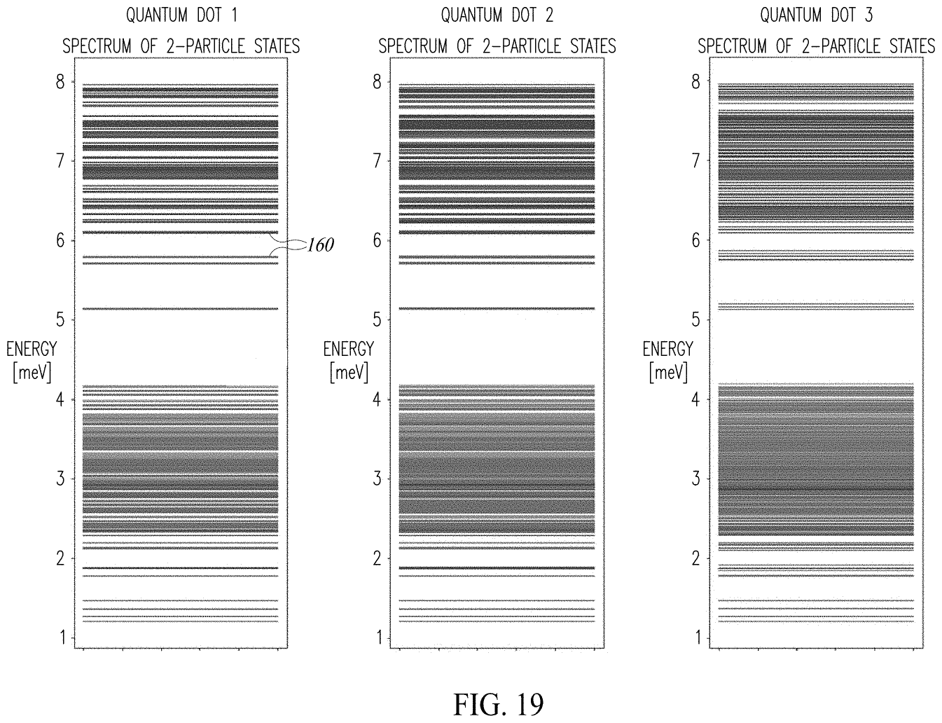

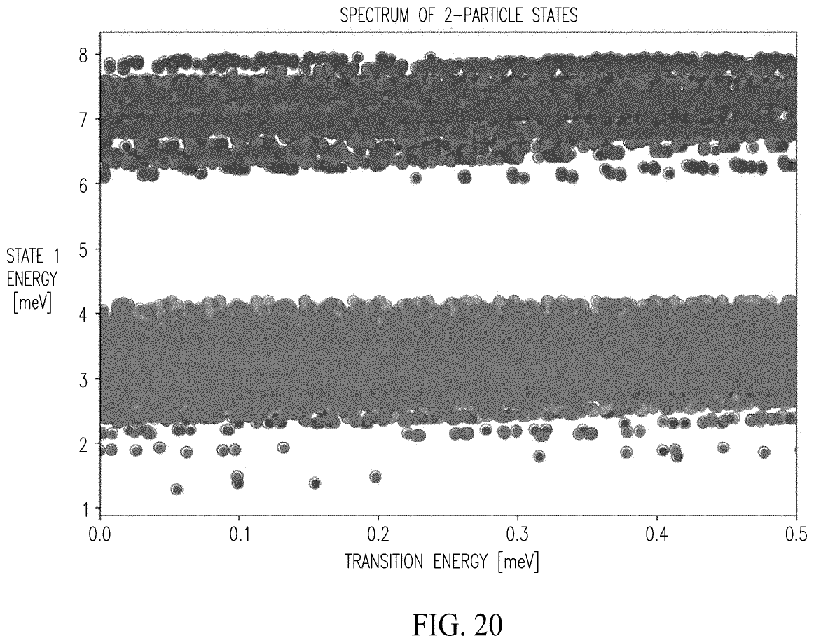

A diagram illustrating the possible energy levels for the three quantum dot system of FIG. 17 is shown in FIG. 19: (left) no magnetic field, (middle) low magnetic field, (right) strong magnetic field. A diagram illustrating the energy spectra of two-electron states for the three quantum dot system of FIG. 5 is shown in FIG. 20. The plurality of energy levels 160 shown correspond to the possible energy states for quantum system of three qdots and two electrons. In such a system there are tens of thousands of possible energy levels considering that the electron can be represented in many dimensions of the Hilbert space. Examples of dimensions for each electron include its position, spin, etc. The levels are generated by building a finite element framework of the quantum dot array and solving for the energy eigenfunctions and then simulating the transition between the eigenfunctions. Thus, each level represents a solution to the Schrodinger equation. Thus, the two electrons in the qdots and the virtual photon pairs creates a ten thousand dimensional space.

Considering one electron in the QDA, the one electron can have approximately ten energy levels depending on how much light (i.e. microwave photons) can be realistically applied. Shining the appropriate frequency of light will cause the electron to transition to a different energy level. A second electron added to the QDA can also be in ten different levels in each of the three qdots. Also, applying a magnetic field will further extend the number of levels. The level dimensions will thus multiply quickly. Thus, the combination of possible levels can easily reach ten thousand. Detecting the difference between the energy levels yields the lines shown in FIG. 19.

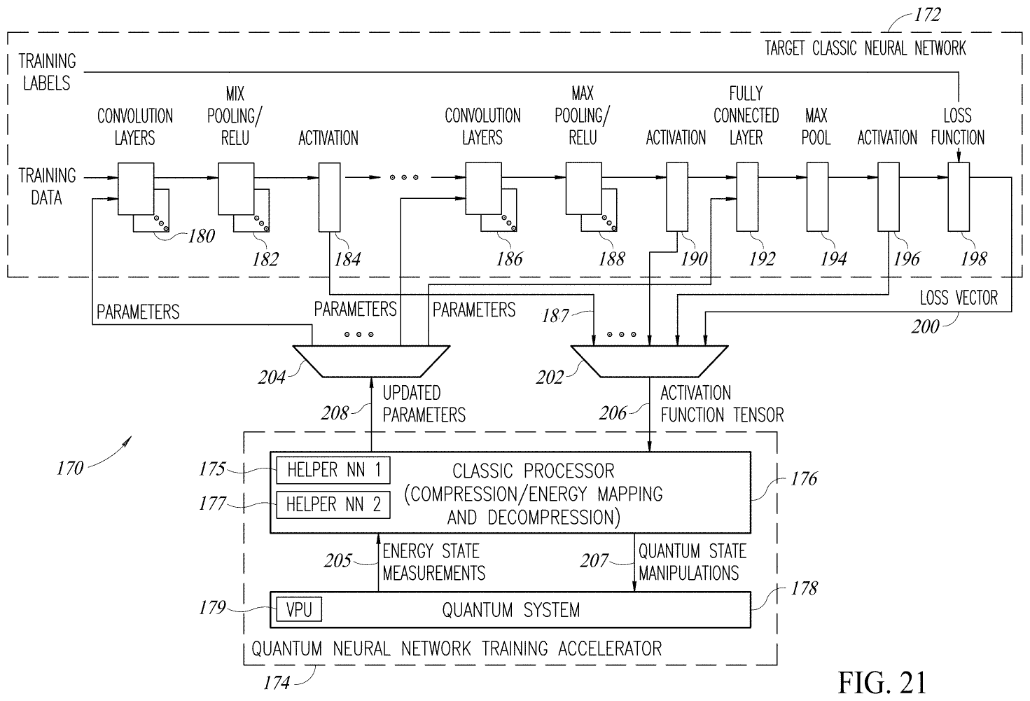

A high level block diagram illustrating a second example quantum accelerated neural network training system is shown in FIG. 21. The system, generally referenced 170, comprises target classic neural network 172 and a quantum neural network training accelerator 174. In one embodiment, the target classic neural network 172 comprises a convolutional neural network (CNN) comprising a plurality of convolution layers 180, max pooling and activation functions 182, e.g., rectified linear unit (ReLU), activation function outputs (tensors) 184, fully connected layer 192, max pool operation 194, activation function outputs 196, and loss function 198. The quantum neural network training accelerator 174 comprises classic processor unit (or vector processor unit) 176 and quantum system 178. In one embodiment, the vector processor unit may be integrated with the quantum system 178. The quantum system 178 may comprise the vector processor unit 179 that is operative to run one or more of the classic helper neural networks as well to execute other functions such as feedforward propagation and backpropagation. The classic processor implements the first and second classic helper neural networks 175, 177 in software, hardware, or a combination thereof.

In one embodiment, the classic processor implements the first and second classic helper NNs as described supra. In particular, the classic processor is operative to receive an activation function tensor 206 from the classic NN representing all activation and loss function outputs in parallel and perform compression (if needed) and energy mapping to generate quantum state manipulations 207 that are applied to the quantum system. It also is operative to perform decompression of the energy state measurements 205 from the quantum system to generate updated parameters 208 that are fed back to the classic NN.

The first helper classic neural network integrates two functions. Along with a reduction in the number of signals by mapping the large number of activation function outputs and loss function to a much smaller number of relevant signal streams, the first helper NN also selects which elements are combined together and mapped to a certain frequency. Thus, it simultaneously performs data reduction as well as mapping which includes the duration the pulses are applied (for example, at the imposers) at a particular frequency.

Subsequent to the quantum system, the second helper NN performs the reverse of the compression step, namely decompression. A reverse max pool or dilated convolution or other suitable filter can be used to expand the output of the detectors in the quantum system. The relatively small number of detector outputs are expanded and distributed to larger matrix.

The mechanism of the present invention is operative to place the quantum system in between the compression and decompression steps (i.e. mapper and demapper) and using it for training and/or inference. Note that in some configurations, the compression or decompression steps might not be needed if the target classic NN is sufficiently simple.

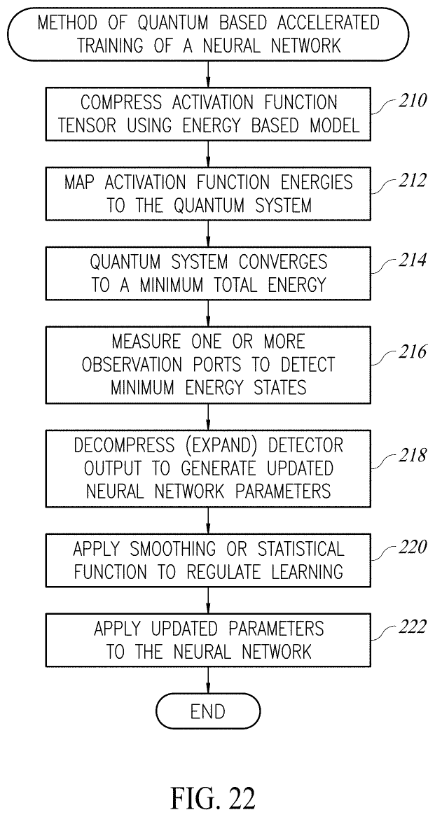

A flow diagram illustrating an example method of quantum based accelerated training of a neural network is shown in FIG. 22. The method is typically performed by the classic processor while the target classic NN is running. Note that depending on the implementation, the quantum system and classic processor may both be located on the same monolithic integrated circuit. Considering the relatively large data flow requirements between classic processor and the quantum system, it is advantageous they be located on the same chip.

In operation, training data and training labels are provided to the target classic NN which executes and propagates the data to generate activation function outputs 187 and a loss vector 200 which are fed to the classic processor via aggregator/collector/multiplexer 204. The activation function outputs and loss vector tensors are compressed using a suitable energy based model, e.g., autoencoder, RBM, etc. (step 210). Note that in most cases compression is required to turn the thousands, millions or even billions of activation outputs to a manageable number of outputs that the quantum system can accommodate. An autoencoder, for example, is operative to take a large dimension space (e.g., Hilbert space) with many activations and condense it down to a small number of significant weights. The helper neural network is a classic neural network that is used to take a very large set and condense it down to a much smaller number of important numbers. The autoencoder can be considered a filter or compression function that essentially filters out the significant part of the activation function outputs.

The reduced number of activations and loss vector energies are then mapped to the quantum system (step 212). Frequencies and pulse durations are assigned to each activation output and applied to the quantum system where the frequency is related to the energy. The frequency determines the energy level relationship and the pulse duration determines the length of the Rabi oscillation that allows the transition from one energy state to the other. In other words, the pulse duration determines how much of the electron's wavefunction is evolved between the corresponding energy levels and the frequency determines where (i.e. the energy level delta) the electron is transported to. The duration sets the probability of the ratio between the original energy level and destination energy level. The result is creation of a very complex product space while using relatively few qubits where bits and pieces of the electron(s) will be in various different energy levels. A decision is made at some point as to where the electron is. The decision, however, represents a soft decision based on probabilities. The result may be for example 70% probability in one energy level, 30% probability in another energy level or neither left nor right qdot with 20% probability. Thus, the mixture of energy levels represents the detection probabilities in the system. In essence, the activations are mapped to a product space of probability density functions. The measurements are made and probabilistic decisions are made, e.g., increment the weight or decrement the weight. Note that a one-time or periodical calibration step may be required for the mapping process.

Note that the mapping step may be performed by a first helper NN. In another embodiment, the energy based model (i.e. autoencoder) (step 210) and mapping function can both be performed by the helper NN. The helper NN is operative to learn better and better how to choose frequencies (energy levels) that yield the optimum result for the optimization.

Note that, typically, the activation function outputs are bound between one and zero or between one, zero, and minus one. One or more electrons in the quantum system are manipulated (i.e. transition between energy states) as the corresponding frequencies and pulse durations are applied. In one embodiment, the mapping process is performed by a helper neural network. Thus, the helper neural network is used to determine the optimum assignment of frequencies since neural networks excel at trying things out to determine what works well and what does not, and slowly converges to the better solution space. It naturally discards what does not work well. Note also that all quantum manipulations must be applied within the decoherence time of the system for a given quantum operation run. Note that the quantum operations can be run multiple times per epoch.

Applying Rabi oscillation frequency for the phase duration of π, yields 100% transition. Transition between energy states may be partial, by applying a pulse duration less than π, e.g., π/2, π/4, π/8, etc. A frequency can be applied for a certain duration to create a transition of 20% to one energy level and 80% to another energy level. Note that the frequency assigned to the activation level is related to the absolute value of the potential energy as E=hf. It is different from the Rabi oscillation frequency (f_{R}) which is related to the difference (delta) between the energy levels as ΔE=h f_{R}.

Note that the quantum system may comprise one or multiple radiators (of photons) that function to generate the frequencies applied. Multiple frequencies may be generated in one complex waveform. In addition, the frequencies can be applied sequentially, in parallel, or a series/parallel combination depending on the number of the particular quantum system implementation used, the main constraint being the decoherence time of the system.

Given a classic NN having N activations, one rule of thumb for the compression stage is to compress the activations to a reduced number of approximately \sqrt{N}. This determines the number of energy levels and thus frequencies needed to implement the system. For example, given a target classic NN to be training having one million activations, this number would be compressed to approximately 1000 activations and each assigned a unique frequency representing an energy level in the quantum system. In one embodiment, the frequencies generated by digital to analog converters (DAC) are separated by one megahertz to yield a frequency span for the product space of one gigahertz. Note that the current capabilities of IC electronics can handle this frequency separation quite easily and can provide sufficient spectral purity.

Another way to determine how much to compress the activations, is to employ well-known principal component analysis (PCA) which is a dimensionality reduction method often used to reduce the dimensionality of large data sets, by transforming a large set of variables into a smaller one that still contains most of the information in the large set. Reducing the number of variables of a data set comes at the expense of accuracy, but in many cases a little bit of accuracy can be traded off for simplicity. PCA can be used to determine the key activations (i.e. related to features) of the target classic NN. The results can be used to ensure the reduced activation set includes key information.

The quantum system then is allowed to converge to a minimum total energy (step 214). For the case of sequential application of frequencies, each activation output frequency applied causes the electron to move between energy levels. At some point, the final activation output frequency is applied and measurements are taken via detectors at one or more observation ports to detect minimum energy states (step 216). What was generated is the probability of where the electron is, which is a function of the cross product of all the frequency pulses applied to the quantum system. Note that a one-time calibration step may be required to learn the optimum energy mapping measurement time for minimum energy detection. Considering the pulse modifications that are performed, the system determines the optimum time to actually detect the edge state and how close it is to the minimum energy. Further, statistical sampling may be performed to find the highest probability.

The detectors mainly detect minimum energy states because the wavefunctions with the minimum energy levels are naturally located at the ends of the rows of quantum dots at the point where the electrons are injected. It also helps to ensure a bit lower potential energy level for the edge qdots, as shown in FIG. 17. The system is setup such that the absence or presence of the electron determines whether to increase, decrease, or do nothing to the weights.

Considering the three qdot array of FIG. 17 for example, with one weight to be updated (for example, increment or decrement) assigned to each detector output, if during measurement an electron is detected (i.e. ‘1’ output), then the weight is decremented or incremented (or left unchanged) depending on the design and implementation of the system. Conversely, if an electron is not detected (i.e. ‘0’ output), then the weight is incremented (i.e. in the opposite direction). In the case where two detectors are assigned to a single weight then the direction and magnitude of the weight update depends on the quantum energy distribution arrangement such that the overall system tends to descend towards the lower quantum energy. Considering this, for example, if an electron is detected in either detector (i.e. ‘10’ or ‘01’ output) then the weight is decremented. If an electron is not detected in either detector (i.e. ‘00’ output) then the weight is incremented. If during measurement an electron is detected in each of the detectors (i.e. ‘11’ output), then the weight is decremented.

In another embodiment, quantum tomography may be performed to glean additional information about the state of the system. In quantum tomography, additional frequencies are applied that shift higher energy levels down to the minimum energy level so that they could be better observed by the detectors. The shifting in energy levels is achieved by applying appropriate Rabi oscillations to force upper energy states into lower states. After shifting, measurements are taken and the information from the detectors is used in determining the weight updates. Note that this process may be used with helper NNs comprising RCNNs as these have a time element suitable for the additional time required to perform quantum tomography. The RCNNs may be deployed for both inference as well as training embodiments.

The measurement results from the detector outputs are then expanded (i.e. decompressed) to generate updated NN parameters, e.g., updated weights and/or biases (step 218). In one embodiment, the decompression process is performed by a second helper neural network. In one embodiment, the second neural network is operative to perform inverse or reverse max pooling where a relatively small number of detector outputs is fanned out to a much larger number of weight and bias updates. The weight updates may be implemented as increment, decrement, or leave unchanged in accordance with the ones and zeros read from the detectors.

For example, consider a quantum system comprising a quantum dot array arranged as several rows of qdots with a detector at the left and right end of each row. Assuming each detector corresponds to a weight, one possible outcome would be if during measurement an electron is detected (i.e. ‘1’ output), then the corresponding weight is decremented. Conversely, if an electron is not detected (i.e. ‘0’ output), then the corresponding weight is incremented.

In another embodiment, each detector output controls not a single weight but rather a group of weights. For example, in the case of a target convolutional NN, all the weights associated with a kernel are grouped together and update in unison. For example, for a 3×3 kernel, all nine weights are updated together.

One or more optional smoothing or statistical functions are applied to the updated parameters to regulate the learning process (step 220). The updated NN parameters are then applied to the classic neural network (step 222).

Note that in one embodiment, the assignment of frequencies to activation outputs is initially done in random fashion. After solving for the minimum energy level in the quantum system, the measurements are used to generated NN parameter updates. The neural networks themselves (i.e. the target and two helper NNs) itself are operative to determine the most optimum solution because the loss vector is part of the input to the first helper neural network, i.e. mapping step 212, which functions to find better assignments for the frequencies to yield the minimum loss vector. This process is iterated until meaningful results are generated.

Alternatively, the assignment of frequencies to activation outputs is performed where frequencies close together are assigned to activation function outputs that represent related features, etc. Thus, the allocation of frequencies is not random but follows a preconfigured ordering of frequencies whereby close energy levels are mapped to probabilities that are close together. For features that should be coming out of the quantum system similarly, it is desirable to have similar results. For features that are very separated, it is desirable to have energy states are far apart.

In one embodiment, the frequencies are assigned to activation functions and loss vector randomly. The system via the helper NNs and quantum system functions to optimize the frequency assignments by itself. Thus, the optimization of the training/learning problem (i.e. frequency assignment) is now part of the larger problem (i.e. classic NN weight learning) that the helper neural networks needs to solve. Typically, the energy levels of the quantum system are not precisely known a priori since determining them is extremely complex and difficult. The frequency assignment (i.e. energy level) is therefore done randomly and then the system is operative to optimize the assignments. The loss vector (i.e. loss function) can be used as reinforcement learning. If it performs well (i.e. converges), it remains or dithers, otherwise it is modified to improve the results. Thus, over many iterations, the frequencies that yield better results will stick and those that do not, will be modified. Initially, random assignments can be made. Those frequencies that optimize correctly are kept and those that do not optimize correctly (based on the loss function) are swapped out.

One type of optimizer suitable for use with the present invention is the quantum annealer which can find the global minimum of a given objective function over a given set of candidate solutions (candidate states), by a process using quantum fluctuations (in other words, a meta-procedure for finding a procedure that finds an absolute minimum size/length/cost/distance from within a possibly very large, but nonetheless finite set of possible solutions using quantum fluctuation-based computation instead of classical computation). Quantum annealing is suitable for problems where the search space is discrete (combinatorial optimization problems) with many local minima.

Note also that quantum systems in general are naturally well suited for solving optimization or energy level based problems or tasks. If the problem is mapped to appropriate energy levels then the natural behavior of the quantum system can be exploited to converge to the lower energy state.

Therefore, the system is operative to take a very large number of activations including a loss vector and setting up experiments in the quantum system, radiates microwave photons in accordance with the activation functions and loss vector. All the activation frequencies then collapse into a relatively small number of detector outputs. The quantum system reads the detector outputs (e.g., 0's and 1's) and based thereon the system updates one or more weights and biases in the classical NN, i.e. each weight is either incremented or decremented, or incremented, decremented, or left unchanged. In one embodiment, each detector is associated with one weight. The number of weights updated, however, can be greatly expanded by use of the second helper neural network that functions to decompress the detector outputs.

Note that the above process is iterated many times whereby a product space is built up via the many activation and loss vector frequencies and then the product space collapses by reading the detector output. In essence the product space is being populated and de-populated with the equivalent of sine-cosine functions that represent probabilities of wavefunctions.

Note further that in one embodiment, along with assigning a frequency and pulse duration to an activation, the electron is also assigned a spin. Thus, the frequency set is essentially doubled since the spin can be either up or down. This allows a QDA having a relatively small number of qdots to have hundreds of thousands or millions of possible frequencies to assign.

It is appreciated that problems such as funding optimum weights in a NN are well suited for solving using a quantum system. By applying activation function output and assigning frequencies (i.e. energy levels) the quantum system automatically performs a probabilistic update for the weights. The probability and stochastic features are built into the quantum system since it is naturally a probabilistic system.

It is also noted that due to the well-known phenomena of transfer learning, a neural network once trained can be used for applications other than the original application. For example, a network trained to detect cats and dogs can be used with a relatively small addition learning step to detect space garbage or houses for satellite image processing. Considering the system of the present invention, once the first and second helper neural networks are trained for a particular classic NN and their weights are optimized, they can be used without major retraining to run or train other classic neural networks since the large majority of their weights are already optimal. The system relies on transfer learning that the previous training to find optimum frequencies and pulse durations to assign to activation functions is still valid. Typically, only the last layer needs to be optimized for the new application.

Thus, the helper neural networks do not have to be trained from scratch. The previous training can be used because the quantum system and its particularities drove the selection of frequencies and the mapping of the detectors. It is assumed that the optimization done the first time for training a NN will work for training other NNs in the future.

In one embodiment, the quantum system comprises redundant elements in the event of one or more failures. For example, entire row of quantum dots in FIG. 7 may be reserved for redundancy in the event of a failure of another row.

It is also noted that the system including the quantum system is rather resilient to hardware failures as well as bad initialization of the neural networks. Consider initially assigning random numbers to the weights of the helper NNs. This is not critical because after a short amount of input data, e.g., a few hundred images, the system figures out that one or more of the frequencies it assigned to activations are not ideal (based on the loss function). Consider for example a failure of one or two detectors in the quantum system. In this case, the system will learn to ignore the output of the two detectors and focus on the ones that operate correctly.

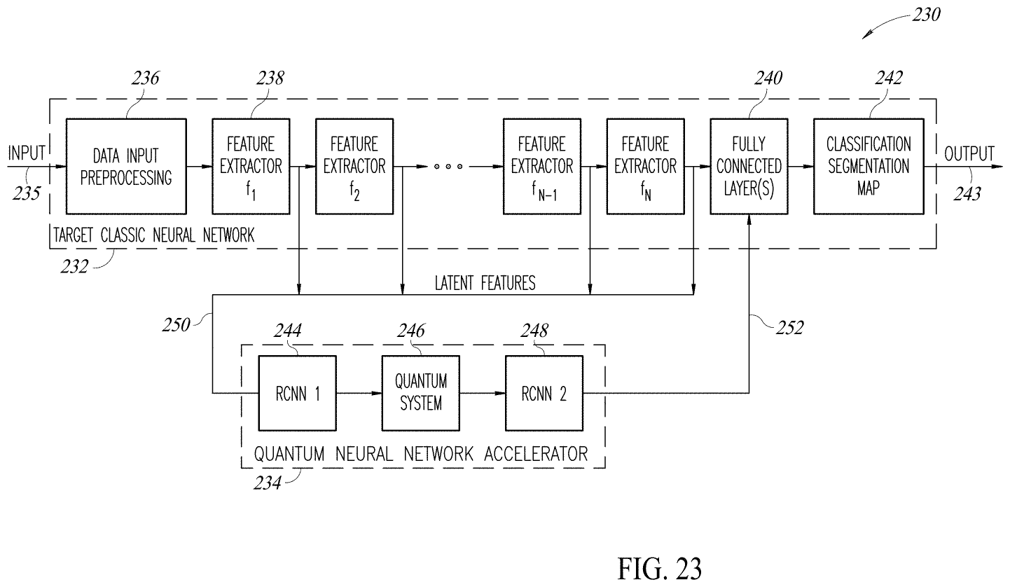

A high level block diagram illustrating example quantum accelerated neural network inference is shown in FIG. 23. The system, generally referenced 230, comprises a classic NN 232 connected to a quantum neural network accelerator 234. The classic NN 232 comprises data input preprocessing block 236 that receives the input data 235, feature extraction layers f₁ through fₙ 238, fully connected layer 240, and classification/segmentation map 242. Similar to the quantum neural network training accelerator 107 (FIG. 2), the quantum neural network accelerator 234 comprises first and second helper neural networks 244, 248 wrapped around quantum system 246. In this embodiment, the first and second helper neural networks 244, 248 comprise recurrent neural networks (RNNs) or recurrent convolutional neural network (RCNNs).

A recurrent neural network (RNN), a type of feedforward neural network, is a neural network which has an internal state machine. With the RNN, the quantum system is not just operated with a single measurement, but with a sequence of measurements and a sequence of manipulations. A RNN is different from a CNN because information flows back to the input of the RNN and because the RNN has memory enabling time loops. Note that since the recursive NNs 244, 248 inherently track time since they have history and are sufficiently complex and feature rich, that they can naturally compensate for time alignment differences between the classic NN 232 and the quantum NN accelerator 234.

The system exploits the quantum NN accelerator 234 to accelerate inferences per second speed by performing complex nonlinear calculations which are normally performed by a classic cascade of convolution, ReLU, max pooling, and fully connected multilayer perceptron blocks. This is achieved by first training the quantum NN accelerator to learn the complete or partial functions of the classic neural network path. During the accelerated path the quantum NN accelerator is enabled to provide much faster inference times.

The system employs a parallel quantum NN accelerator circuit 234 that provides a significant acceleration to inference (i.e. prediction). The speed of inference is greatly increased as the results of the quantum NN accelerator are in the order of the decoherence times (i.e. nanoseconds) compared to 10msec for current state of the art machines.

It is noted that today's current solutions are limited by the processing speed of the artificial intelligence (AI) inference architecture, where it is acceptable to replace the human in the loop tasks by operating at a speed slightly faster than humans. This is inadequate, however, for specialist operations where tracking multiple images in real time is required. Currently, there is no competitive solution available using available silicon based technology.

In operation, the latent feature output 250 of one or more of the feature extraction layers is input to the RCNN 244 in the quantum NN accelerator which functions as a mapping NN. The output of the first RCNN is a sequence of quantum state manipulations that are applied to the quantum system 246. A sequence of measurements of the detector output are input to the second RCNN 248 which functions as a detection NN. The accelerator path 252 output of the second RCNN is applied to the fully connected layer as additional inputs. Note that the fully connected layer is where the final mapping from all the feature calculations is performed to generate the output 243 of the classic NN. The RCNNs are trained to have meaningful weights using the loss function which backpropagates through the RCNN.

Note that the system of FIG. 23 is similar to that of FIG. 2 with the difference being the RNNs in the inference bypass path in the system of FIG. 23 rather than CNNs. The RNNs enable multiple set ups and multiple read outs which is required to perform quantum tomography. In this case, the weights of the classic NN may be classically trained. Thus, even if the quantum system is only used for inference and no quantum enhanced training is performed, a significant speedup can be achieved.

In this case, the first RNN in front of the quantum system functions to condense the input stream and make it more compact. In one embodiment, the RNN is a recurrent convolutional neural network (RCNN) incorporating internal memory, feedback, and thus has a state. Rather than perform a single measurement and make a single decision, the RCNN facilitates multiple measurements of the quantum system enabling quantum tomography and reading out the full feature set of the system. For example, consider that the lowest energy state was initially set up but has is deviated from because the activation is not perfect and the electron was put into a different energy level(s). Rather than simply detect that a portion of the electron is in, for example, a first energy level, multiple reads are performed to better determine the full quantum state providing more complete information. Instead of doing, for example, one single measurement, multiple measurements are performed to reveal all possible states.

In operation, the quantum system is set up, let to converge, and then is read out. In a single cycle, the quantum system provides a probability that something is wrong since it functions as a statistical probabilistic engine. This probability is a soft result. This is in contrast to classic NN which needs to perform many thousands of iterations to provide any kind of probability.

Not only is the classic NN trained but both RCNNs are trained as well to yield the optimum pulse sequence into the quantum system. The optimum measurement sequence is read out of the quantum system to yield the best input into the classification of the classic NN. Precise knowledge of all the energy levels in the quantum system is not required as it can have errors and noise. These can be compensated for in the RCNNs. The output of the second RCNN 242, which includes information on what features it considers important, is fed to the fully connected layer 240 in the classic NN. The output along with the classically extracted parameters are input to the fully connected layer. The input to the fully connected layer is ‘spiked’ with a richer spectrum of important features.

The RCNNs function as selective filters which are trained to filter for the desired information. The system is operative because the RCNNs and quantum system are part of the training process. This aids the classic NN to converge. Note that preferably the mechanism is applied to difficult, hard to decide features. The simpler, easier to decide features can go to the classic path. Thus, the mechanism is operative to extract a certain set of features in the inference path of the classic NN which is fed in parallel to the RCNNs and quantum system to estimate the important features. These are then applied to the fully connected layer. A relatively small quantum system combined with quantum tomography can have a large impact on the time and cost of implementing large classic NNs. The RCNNs are used to train how to optimally integrate a quantum system in the data flow of a classic NN.

As described supra, considering the possible energy levels and related frequencies (i.e. ‘colors’), a mapping is performed where the product state space generated from the features and loss function is mapped to certain frequencies. It is preferable to make the mapping of the frequencies such that the features and activations that are close together and have similar importance, are applied to frequencies which are close together. And the features and activations that are unrelated to each other, are applied to frequencies which are far apart. An example of this is shown in FIG. 23 where activation function outputs that are close together such as activation group 280 are assigned frequencies close together. Activation function outputs that are far apart such as activation group 282 are assigned frequencies further apart from each other. Note that only a few activation output levels are shown for clarity. In practice there may be hundred, thousands, or millions of activations. See, for example, the large number of energy levels described supra and shown in FIG. 19.

Thus, the present invention provides a mechanism for determining what frequencies are the optimum mapping, i.e. how to formulate this as an energy function that yields the optimum mapping between the energy function coming in from the classic neural network, the activations, and the loss function, and how to map it to the quantum system. Thus, the frequencies (energy levels) that are assigned in the mapping function (i.e. the first helper NN) (step 212 of FIG. 22) are selected assigning frequencies whereby closely related activation output values are assigned to closely related frequencies, and vice versa whereby non-closely related activation output values are assigned to frequencies further away. For example, if two activations are relatively close in value, the activation assignment is such that they are relatively close in frequency. Thus, rather than perform a random assignment as described supra, a more optimum technique of selecting frequencies to assign to activation functions is provided where the frequency assignment is made so closely related features are assigned closely related frequencies.

The mechanism determines the assignment of the frequency (equivalent to energy state) to an activation. Considering the example diagrams of FIGS. 19 and 24, the energy levels are somewhat clustered. They are not completely random and equidistant from each other. Based on the output classification result, it is known that certain solutions are quite similar to each and certain solutions are very different from each other. Further, certain solutions are highly unlikely and certain solutions look like very good candidates. It is preferable to take the solutions which are quite similar and equally probable and map these to denser energy levels. The solutions that are not very likely and quite distant from one another are mapped to energy levels with larger energy separation. Thus, the probability of something being correct is a good measure for where to assign them in the energy map. This is because when the quantum algorithm chooses the final result and selects the energy levels with a certain noisiness, then if the levels which belong together are grouped closely together, good sampling for randomly picking the right one can be achieved.

The mechanism can be used in the first helper neural network 108 (FIG. 2) in determining the energy level mapping whereby energy levels (i.e. frequencies) are assigned to activation function outputs.

The rationale for doing this is that considering that the quantum system exhibits a certain amount of noise which causes inaccuracies in the frequencies. In other words, the noise inherent in the quantum system causes some energy level assignments to miss their intended frequencies and land on a frequency that is close to the target. Inherently, a certain number of mistakes in frequencies that are close to each other will occur. To address this, the invention groups together all the things having approximately the same probability. Thus, the frequency that is assigned is such that an initial guess is made for the optimum choice, based on representing the distance and the input activation function as the frequency spacings in the quantum system.

In this case, noise is actually helping the system rather than hindering it. This is because a neural network performs better when it is trained with noisy data, e.g., noisy images. It is desirable to be able to handle noisy images, i.e. to detect imperfect images. It is thus desirable to assign frequencies that are close together to features that belong together. Features are close together when for the same image, they yield similar levels of activation.

In one embodiment, the quantum system can be viewed as a quantum state machine with N possible states with energy E(a, N). By manipulating a sequence of parameters, such as imposers in a quantum dot array (QDA), we can create one minimal energy state Eₘᵢₙ(X). That state can be reached using quantum annealing or directly generated by the appropriate parameter sequence. In a NISQ, however, the energy separation between the minimum state and the next lowest energy state will be relatively small compared to the noise level in the system leading to readout errors. Because not all states have the same energy separation, however, it is beneficial to identify those states having the highest energy separation.

A helper learning network can be used to optimize the features such that the output, classifies or ranks the minimum energy separation. The neural network provides a pattern and a classification algorithm that maximizes the following objective function:

For a quantum system having N possible states with Energy

E(min_diff)=E min(a)−argmin(E−E min(a)]
Sort E(min_diff) in order highest to lowest, resulting in best candidates
Output an ordered list of N states sorted by energy separation therebetween

Based on the results of the above method, changes are made to the quantum system to maximize the largest energy separations. Thus, the mechanism uses the difference between the probabilities to assign which frequencies will be used in the quantum system.

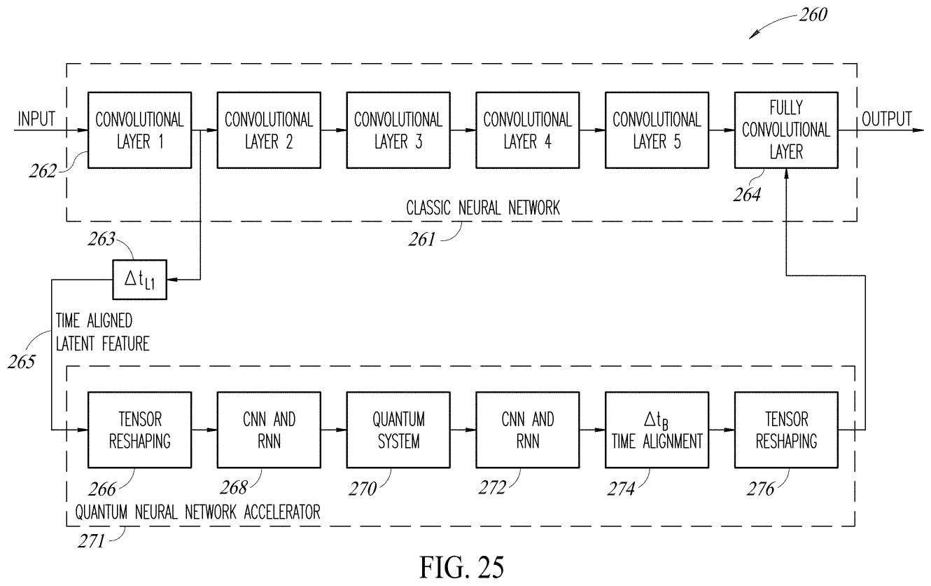

A high level block diagram illustrating a first example time and tensor shape matched and balanced architecture is shown in FIG. 25. The system, generally referenced 260, comprises a classic neural network 261 and a quantum neural network accelerator 271. The classic neural network 261 comprises a plurality of convolutional layers 262, i.e. convolution layers 1 through 5, and fully connected layer 264. The quantum neural network accelerator 271 comprises a first tensor reshaping block 266, first helper convolutional NN/recursive NN 268, quantum system 270, second helper convolutional NN/recursive NN 272, time alignment block 274, and second tensor reshaping block 276.

As described supra, in connection with FIG. 2, the system employs nested neural networks where the outer classic NN is supplemented by two inner helper classic NNs surrounding the quantum system. During operation, however, the classic NN 261 may get out of time synchronization with the quantum NN accelerator 271 due to the difference in nature of the processing performed by the quantum and classic systems. The difference in timing between the two can be compensated for by inserting a time alignment block in the quantum NN accelerator path (i.e. time alignment Δt_{B}block 274) and/or between the output of the convolutional layer 1 262 (i.e. time alignment Δt_{L1} block 263) and the input to the tensor reshaping block 266. In one embodiment, the time alignment block 274 comprises a base correction that is always applied for all layers (e.g., 100 nsec delay layer to layer) while the layer 1 alignment block 263 provides ‘fine tuning’ of the alignment for the delay caused by layer 1 and may or may not be needed. The time aligned latent features 265 from Δt_{L1} block 263 is input to the tensor reshaping 266.

Note that since the two recursive NNs 268, 272 inherently have history and a sense of time, they can naturally compensate for time alignment mismatch between the classic NN 261 and the quantum NN accelerator 271. To aid in understanding the present invention, however, the time alignment is shown as a separate block 263. Assuming that the quantum path is faster (e.g., 10 nsec), the time alignment 274 will be positive (i.e. time is added and thus the quantum path is delayed). In the event the first convolutional layer 1 output is applied to the quantum NN accelerator, the time alignment 274 compensates for the faster processing speed of the quantum system. Thus, the output of the quantum path will be in sync with the processing carried out on the classic path.

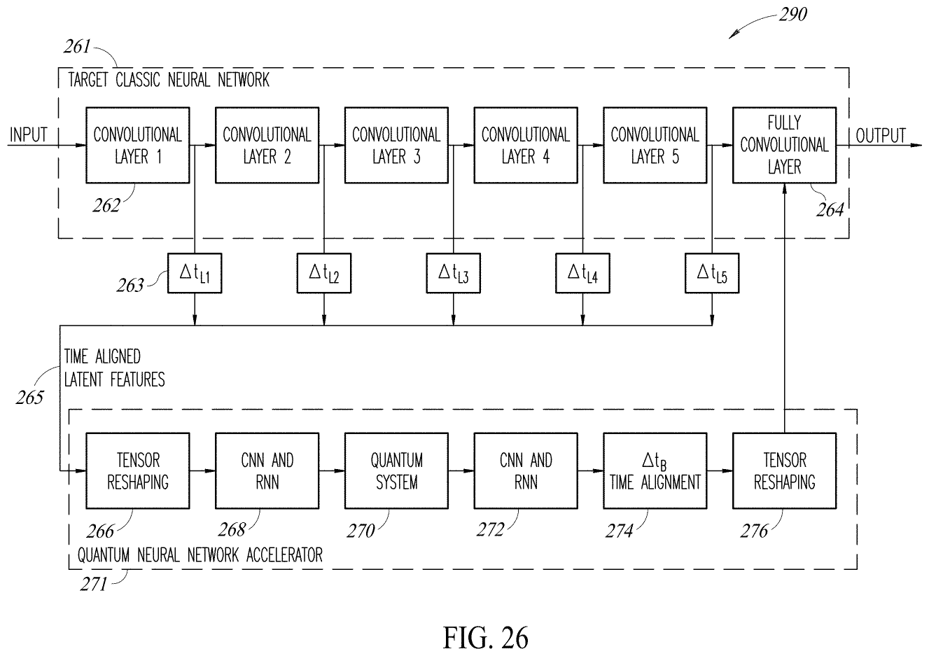

A high level block diagram illustrating a second example time and tensor shape matched and balanced architecture is shown in FIG. 26. The system, generally referenced 290, is similar to system 260 shown and described in FIG. 25 supra. The different being that a time alignment block is inserted between the latent feature output of each convolutional layer, i.e. convolutional layers 1 through 5, rather than just from layer 1. Thus, the time alignment 263 of the features output of each convolutional layer can be individually configured along with the base time alignment 274. The time aligned latent features 265 are input to the tensor reshaping block 266.

As a result of performing complicated mapping as described supra, the quantum system is likely to have a lot of fixed pattern noise. The energy level spectrum such as shown in FIG. 19 is very sensitive to the actual shape of the quantum system, e.g., QDA. Making a small change results in the frequency spectrum getting shifted around. In accordance with the system of the present invention, however, it is not critical because the system has the capability of compensating for errors in the frequency map by training the system to use the correct frequency assignment. Thus, the presence of fixed pattern noise in the quantum system is not necessarily harmful in this context.

In actuality, the individual energy levels do not need to be calculated. Changing the shape of the quantum system by a one half nanometer, which is the natural uncertainty of the manufacturing process, results in a change to the energy level spectrum. It is only important that on average, the correct frequency map is generated. The two helper neural networks are operative to take care of subtle differences in the actual quantum system obtained. Thus, the difference due to manufacturing fluctuations and process variations can be compensated for by doing calibration using the two helper neural networks.

This mechanism can also compensate for a failed qdot or row of qdots caused by a manufacturing defect or destructive event during operation. In one embodiment, redundancy can be provided where additional qdots are available to replace failed qdots either initially or over time to provide radiation hardness capability, for example.

In this embodiment, the fixed pattern noise which exists in quantum systems which are not always the same as they will have manufacturing fluctuations. The fluctuations are compensated for by doing pre-training with known training data and the frequency assignment is optimized until the best possible training is achieved.

In practice, the electron is assigned to an activation represented by a frequency which is applied to the quantum system. A measurement is then made and it is determined how well the assignment performed. If the assignment was not good, meaning the frequency did not cause the desired result, the frequency is reassigned to another activation. The optimum frequency assignment is thus determined on the fly. Considering two quantum systems, they both likely have different noise patterns. This is not a concern as the two helper neural networks figure out the correct frequency assignment during the initial training phase when the system is first brought up. Once found, the correct frequency assignment is used in all other instantiations of the quantum system through the use of transfer learning to initialize the helper neural networks.

The correct frequency assignment is determined after the detector measurements are made. The quantum system is initialized in an initial training stage with a known problem. And then the fixed pattern noise is compensated by calibration such that the frequency assignment is optimum. In operation, a certain assignment of frequencies is performed to see how well they perform. If they perform well, they are kept unchanged. If they did not perform well, they are changed and the process repeats until a good performing frequency assignments are found which should eliminate the fixed pattern noise.

For example, assume a frequency is assigned to an activation that was not really available. In this case, a transition of the electron will never occur and the particular activation will never impact the output. The system will indicate that a bad assignment of frequencies was made and no result generated. The system will change the frequency. Thus, during the pre-calibration phase where the network is trained for the first time, it is determined what the available frequencies are. In addition, the very first training is not optimized training, but rather is optimizing the frequencies used.

It is appreciated that one skilled in the art can combine the above described embodiments, methods, and techniques in any desired combination to create additional systems that e.g., accelerate learning of a classic NN, accelerate inference of a classic NN, improve reliability, increase speed, reduce energy consumption, etc. For example, RCNNs may be used in the help NNs not just for inference but for training acceleration as well. In addition, quantum tomography may be used for both inference and training acceleration.

Those skilled in the art will recognize that the boundaries between logic and circuit blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediary components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the claims, any reference signs placed between parentheses shall not be construed as limiting the claim. The use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first,” “second,” etc. are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of quantum enhanced accelerated training of a neural network, said method comprising:
receiving a plurality of activation function tensors corresponding to features across layers in the neural network;
mapping said plurality of activation function tensors of the neural network to energy levels representing a quantum state in a quantum system;
detecting minimum energy states at one or more observation points in said quantum system after said quantum system converges to a minimum total energy; and
determining an update to one or more neural network parameters in accordance with said one or more minimum energy states detected.

2. The method according to claim 1, wherein said quantum system comprises an array of quantum dots.

3. The method according to claim 1, further comprising compressing said plurality of activation tensors using an energy based model.

4. The method according to claim 1, further comprising utilizing a first helper neural network to reduce the number of signals input to said quantum system before quantum operations are performed.

5. The method according to claim 1, further comprising expanding detected results output from said quantum system into a larger set of said neural network parameter updates utilizing a second helper neural network.

6. The method according to claim 1, wherein only a certain subset of energy levels are observable in quantum detectors during said detecting.

7. The method according to claim 1, wherein said detecting comprises achieving quantum read out by performing multiple quantum non-demolition read-outs in sequence to yield nearly complete information.

8. The method according to claim 1, wherein said one or more neural network parameters comprises weights and/or biases.

9. The method according to claim 1, wherein detecting comprises performing quantum tomography to measure higher energy state levels by shifting higher energy levels down to said minimum energy state.

10. A quantum optimizer apparatus for accelerating training of a neural network, comprising:
a quantum system;
a classic processor coupled to said quantum system and operative to:
receive one or more neural network activation function tensors;
compress said activation function tensor utilizing an energy based model;
map activation energy represented by said energy based model to quantum states in said quantum system;
detect an energy state at one or more observation ports in said quantum system after said quantum system collapses to a minimum total energy; and
determine updates to one or more neural network parameters in accordance with one or more energy states detected.

11. The apparatus according to claim 10, wherein said quantum system comprises a plurality of quantum dots.

12. The apparatus according to claim 10, wherein said quantum system comprises a quantum dot array including said plurality of quantum dots organized in a plurality of rows with at least one observation port on either end of each row.

13. The apparatus according to claim 10, wherein said activation function tensor is compressed utilizing a helper neural network.

14. The apparatus according to claim 10, wherein a different imposer frequency is assigned to each activation function, and wherein imposer signal durations correspond to activation levels.

15. The apparatus according to claim 14, wherein a pulse duration of an imposer signal determines a probability ratio between an original energy level and a destination energy level based on a Rabi oscillation process.

16. The apparatus according to claim 14, wherein said classic processor is further operative to map quantum states back to known imposer values that yield minimum energy values.

17. A method of quantum enhanced accelerated training of a neural network, said method comprising:
receiving a plurality of activation function tensors corresponding to features and layers in the neural network;
compressing said plurality of activation function tensors of the neural network utilizing an energy based model to reduce the number of activation function tensors;
mapping said reduced number of activation function tensors signals to energy levels representing quantum state in a quantum dot array incorporating a plurality of quantum dots;
detecting minimum energy states at one or more observation points in said quantum dot array once said quantum dot array converges to a minimum total energy; and
determining an update to one or more neural network parameters in accordance with said one or more minimum energy states detected.

18. The method according to claim 17, wherein said compressing comprises compressing said plurality of activation function tensors utilizing a helper neural network.

19. The method according to claim 17, wherein each activation function is assigned an imposer signal frequency applied to one or more quantum dots, and wherein said imposer signal frequency determines an energy level of one or more quantum dots in said quantum system.

20. The method according to claim 19, wherein a duration of each frequency applied to an imposer is roughly proportional to an activation level.

21. The method according to claim 19, wherein a pulse duration of an imposer signal determines a probability ratio between an original energy level and a destination energy level based on a Rabi oscillation process.

22. The method according to claim 19, further comprising mapping quantum states back to known imposer values that yield minimum energy values.

23. A quantum optimizer apparatus for accelerating training of a neural network, comprising:
a quantum system;
a first neural network coupled to said quantum system and operative to:
compress a plurality of activation and loss function outputs from a classic neural network utilizing an energy based model to generate a reduced number of activation and loss function outputs;
map the reduced number of activation and loss function outputs to unique quantum state energy levels in said quantum system;
wherein said first neural network is operative to select an optimum choice of frequencies and pulse durations to apply to said quantum system;
a circuit operative to apply said energy level mappings to said quantum system;
a plurality of detectors operative to detect an energy state at one or more observation ports in said quantum system after said quantum system evolves to a minimum total energy; and
a second neural network coupled to said quantum system and operative to generate updates to one or more neural network parameters to said classic neural network in accordance with a plurality of detected energy states thereby training said classic neural network.

24. The apparatus according to claim 23, wherein said first neural network and/or said second neural network learn one or more characteristics of said quantum system.

25. The apparatus according to claim 23, wherein said quantum system comprises a plurality of quantum dots.
